(19) United States
(12) Patent Application Publication
(10) Pub. No.: US 2015/0174004 A1
(43) Pub. Date: Jun. 25, 2015

(54) TABLET PACKAGING BODY

(71) Applicants: Tomoharu Miyamoto, Tokyo (JP); Kazumasa Kimoto, Tokyo (JP); Yoshimichi Ohya, Tokyo (JP); Ryo Yamaguchi, Tokyo (JP); Katsuhiro Shimizu, Tokyo (JP); Masaki Takeda, Tokyo (JP)

(72) Inventors: Tomoharu Miyamoto, Tokyo (JP); Kazumasa Kimoto, Tokyo (JP); Yoshimichi Ohya, Tokyo (JP); Ryo Yamaguchi, Tokyo (JP); Katsuhiro Shimizu, Tokyo (JP); Masaki Takeda, Tokyo (JP)

(73) Assignee: SUMITOMO BAKELITE CO., LTD., Shinagawa-ku, Tokyo (JP)

(21) Appl. No.: 14/363,001

(22) PCT Filed: Feb. 24, 2012
(86) PCT No.: PCT/JP2012/054637

§ 371 Date: Jun. 5, 2014

(30) Foreign Application Priority Data
Dec. 7, 2011 (JP) 2011-268255

(51) Int. Cl. A61J 1/03; B65D 75/36; B65D 75/52; B65D 25/20

(52) U.S. Cl. CPC A61J 1/035; B65D 25/205; B65D 75/367; B65D 75/527

(57) ABSTRACT

A tablet packaging body (100), comprising: a main body sheet (200) and a sealing member (300). The main body sheet (200) has a recessed section (230). The sealing member (300) is sealed to the main body sheet (200) so as to cover an opening in the recessed section (230). The sealing member (300) can be readily peeled from at least one section of the main body sheet (200) such that the recessed section (230) is opened. The recessed section (230) has a size whereby a plurality of medicines (T3) can be housed therein.

### TECHNICAL FIELD

The present invention relates to a tablet packaging body.

Priority is claimed on Japanese Patent Application No. 2011-268255, filed Dec. 7, 2011, the content of which is incorporated herein by reference.

### BACKGROUND ART

In order to prevent an individual who takes a plurality of drugs from forgetting to take drugs or from taking wrong drugs, an operation of putting a plurality of drugs into one package has been performed. For example, as a drug package for such an operation of putting drugs into one package, a drug package including a container having a plurality of recessed sections and a base sheet having a seal for sealing the container has been proposed (for example, see Patent Document 1). By accommodating a plurality of drugs in one recessed section, this drug package enables the incorporation of drugs into one package. Further, the day of the week, time of day and date for taking the drugs are described on the seal and the base sheet. For this reason, it is difficult for a patient to take drugs at a wrong time. Furthermore, doctors, pharmacists, nurses and the like can confirm whether or not a patient has taken drugs in an appropriate manner by checking the empty recessed section in the drug package.

### CITATION LIST

### Patent Document

[Patent Document 1] Japanese Unexamined Patent Application, First Publication No. 2009-485

### SUMMARY OF THE INVENTION

### Problem to be Solved by the Invention

In the above drug package, drugs are taken out by breaking the seal. For this reason, the elderly or crippled patients may not be able to break the seal due to the lack of power, and may not be able to take the drug out from the drug package.

An object of the present invention is to provide a tablet packaging body with which the drugs can be easily taken out from the tablet packaging body even by an elderly or crippled patient (the recipient of the drug).

### Means for Solving the Problem

The present invention includes the following aspects.

(1) A tablet packaging body comprising at least one recessed section having a size capable of accommodating a plurality of drugs; a main body sheet having the aforementioned recessed section; and a sealing member sealed to the aforementioned main body sheet so as to cover an opening of the aforementioned recessed section; wherein the aforementioned sealing member can be easily peeled from at least a part of the aforementioned main body sheet such that the aforementioned recessed section is opened.
(2) The tablet packaging body according to the above aspect (1), wherein at least one of the aforementioned main body sheet and the aforementioned sealing member has a barrier property against at least one of specific gas and light.
(3) The tablet packaging body according to the above aspect (1) or (2), wherein the aforementioned main body sheet comprises a plurality of the aforementioned recessed sections; and at least one of: day of the week, time of day, and date, for taking the aforementioned drugs accommodated in the aforementioned recessed section is described on at least one of the aforementioned main body sheet and the aforementioned sealing member so as to each correspond to the aforementioned recessed section.
(4) The tablet packaging body according to any one of the above aspects (1) to (3), wherein the aforementioned recessed section comprises a plurality of compartments.
(5) The tablet packaging body according to any one of the above aspects (1) to (4), wherein a thickness of the aforementioned main body sheet is not less than 30 μm and not greater than 800 μm.
(6) The tablet packaging body according to any one of the above aspects (1) to (5), wherein at least one of the aforementioned main body sheet and the aforementioned sealing member has transparency.
(7) The tablet packaging body according to the above aspect (1) or (2), wherein the aforementioned main body sheet is in a strip form which can be wound into a roll, and the aforementioned recessed section is at least provided in plurality along a longitudinal direction of the aforementioned main body sheet.
(8) The tablet packaging body according to the above aspect (7), wherein a slit is formed in a width direction in the aforementioned main body sheet.
(9) The tablet packaging body according to any one of the above aspects (1) to (8), wherein the aforementioned recessed section is capable of accommodating a plurality types of the aforementioned drugs.
(10) The tablet packaging body according to the above aspect (1) or (2), wherein the aforementioned sealing member is sealed by a line seal.
(11) The tablet packaging body according to the above aspect (10), wherein a peel strength upon opening the aforementioned sealing member is lower than a peel strength in the middle of opening.
(12) The tablet packaging body according to the above aspect (10) or (11), wherein when a width of an adhesion area at an opening start point is defined as A and a width of an adhesion area at an opening end point is defined as B, A and B satisfies a relationship of A<B.
(13) The tablet packaging body according to any one of the above aspects (10) to (12), wherein the aforementioned sealing member does not peel off in a part of an edge of the aforementioned recessed section.
(14) The tablet packaging body according to any one of the above aspects (10) to (13), wherein the aforementioned recessed section is provided in plurality; and in the aforementioned main body sheet and the aforementioned sealing member, for each of the aforementioned recessed sections, a groove or a cut is provided in a periphery of the aforementioned recessed section which is formed so that the aforementioned recessed sections are each separable.
(15) The tablet packaging body according to any one of the above aspects (10) to (13), wherein the aforementioned sealing member is provided for each of the aforementioned recessed sections.
(16) The tablet packaging body according to any one of the above aspects (10) to (15), wherein a height of the aforementioned recessed section is equal to or higher than a height of the aforementioned drugs and is equal to or lower than a height of two of the aforementioned drugs put together.
(17) The tablet packaging body according to any one of the above aspects (10) to (16), wherein the aforementioned sealing member has a winding property, and the aforementioned sealing member becomes a warped shape in a direction opposite to that of the recessed section when the aforementioned sealing member is peeled off from the aforementioned recessed section.

### Effects of the Invention

The tablet packaging body according to the present invention enables even an elderly or crippled patient (the recipient of the drug) to easily take out a plurality of drugs from the tablet packaging body at a time, and makes the drug management easy.

### BRIEF DESCRIPTION OF THE DRAWINGS

FIG. 1 is a plan view of the front surface of a tablet packaging body according to an embodiment of the present invention.

FIG. 2 is a plan view of the back surface of a tablet packaging body according to an embodiment of the present invention.

FIG. 3 is a cross sectional view taken along the line A1-A1 of the tablet packaging body shown in FIG. 1.

FIG. 4 is a plan view of the front surface of a tablet packaging body according to a modified example (A) of an embodiment of the present invention.

FIG. 5 is a plan view of the front surface of a tablet packaging body according to a modified example (B) of an embodiment of the present invention.

FIG. 6 is a plan view of the back surface of a tablet packaging body according to a modified example (C) of an embodiment of the present invention.

FIG. 7 is a perspective view of a tablet packaging body according to a second embodiment of the present invention.

FIG. 8 is a cross sectional view taken along the line A2-A2 of the tablet packaging body shown in FIG. 7.

FIG. 9 is a plan view of a tablet packaging body as seen from the main body sheet side.

FIG. 10 is a perspective view showing a state in which a sealing member is attached to the main body sheet.

FIG. 11 is a cross sectional view of a tablet packaging body according to a modified example of the second embodiment of the present invention.

FIG. 12 is a plan view of a tablet packaging body according to a modified example of the second embodiment of the present invention as seen from the main body sheet side.

FIG. 13 is a cross sectional view of a tablet packaging body according to a third embodiment of the present invention.

FIG. 14 is a schematic perspective view showing an example of an assembly of a tablet packaging body according to a fourth embodiment of the present invention.

FIG. 15 is a schematic cross sectional side view for explaining the structure of a tablet packaging body.

FIG. 16 is a schematic plan view showing an example of a tablet packaging body.

FIG. 17 is a schematic plan view showing an example of a tablet packaging body.

FIG. 18 is a schematic plan view showing an example of a tablet packaging body.

FIG. 19 is a schematic plan view showing an example of a tablet packaging body.

FIG. 20 is a schematic plan view showing an example of a tablet packaging body.

FIG. 21 is a view showing a state in which a plurality of tablets is accommodated in the tablet packaging body shown in FIGS. 14 to 15.

### EMBODIMENTS FOR CARRYING OUT THE INVENTION

A tablet packaging body according to the present invention comprises at least one recessed section having a size capable of accommodating a plurality of drugs; a main body sheet having the aforementioned recessed section; and a sealing member sealed to (in close contact with) the aforementioned main body sheet so as to cover an opening of the aforementioned recessed section. The aforementioned sealing member can be easily peeled from at least a part of the aforementioned main body sheet such that the aforementioned recessed section is opened. In addition, it is preferable that at least one of the aforementioned main body sheet and the aforementioned sealing member has a barrier property against at least one of specific gas and light.

Here, the expression “sealing member sealed to the main body sheet so as to cover an opening of the recessed section” means that at least a part of the sealing member is sealed to the main body sheet in an airtight manner so that the recessed section is hermetically sealed.

In addition, the expression “the sealing member can be easily peeled from at least a part of the aforementioned main body sheet so that the aforementioned recessed section is opened” means that the sealing property of an internal space of the recessed section is maintained when the opening of the seal is not intended, for example, at the time of distribution and at the time of storage, and also the sealing member can be peeled from at least a part of the main body sheet so that the recessed section is opened easily by the force of the hand without using a tool such as a pair of scissors when the opening of the seal is intended.

Further, the expression “has a barrier property against at least one of specific gas and light” means having the capability to block the transmission of a specific gas (for example, water vapor, oxygen, or the like in the air) and/or light (for example, ultraviolet light or the like) and to prevent the intrusion into the internal space of the recessed section from the outside; and preferably (i) the water vapor transmission rate as measured in accordance with JIS Z 0208 is not greater than 10 g/m²·24 h, more preferably not greater than 5 g/m²·24 h; (ii) the oxygen transmission rate as measured in accordance with JIS K 7126B is not greater than 10 cm³/m²·24 h·atm, more preferably not greater than 1 cm³/m²·24·atm; and/or (iii) the 90% absorption wavelength of light transmittance curve as measured with an ultraviolet-visible spectrophotometer (manufactured by JASCO Corporation, product name: V-650) is not greater than 600 nm.

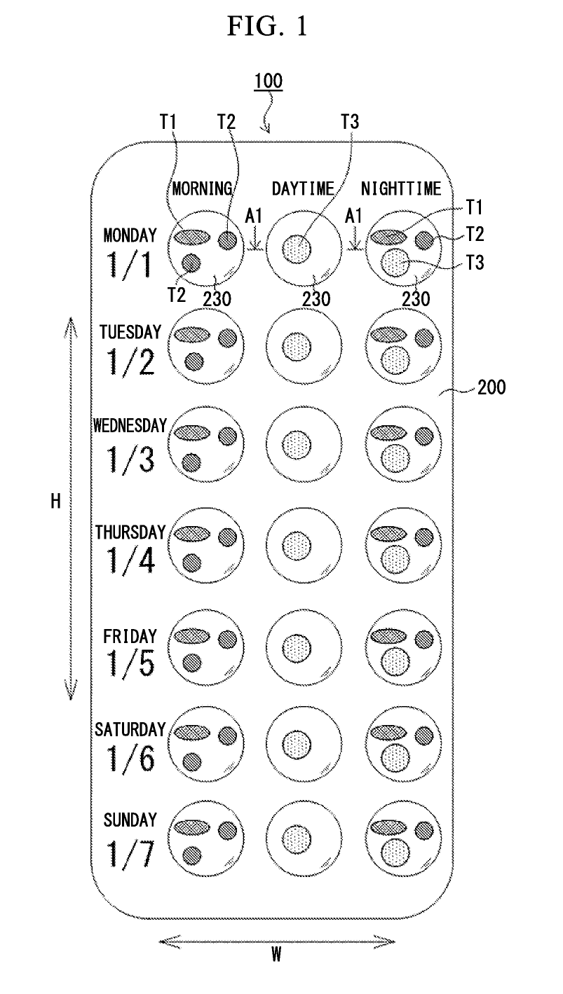

As shown in FIGS. 1 to 3, the tablet packaging body according to a first embodiment of the present invention (a packaging sheet) 100 is mainly configured from a recessed section 230 for accommodating drugs T1 to T3 of different types of tablets, a main body sheet 200 having the aforementioned recessed section 230, and a sealing member 300 which is sealed to at least a part of the aforementioned main body sheet 200 so as to cover the opening of the aforementioned recess 230.

Although the drugs T1 to T3 are not particularly limited, for example, medicines aimed at treating and preventing diseases; supplements for the purpose of supplying nutrition such as vitamins, minerals, and amino acids, and achieving the efficacy of ingredients, or the like can be used.

Each component of the first embodiment will be described in detail below.

### <Recessed Section and Main Body Sheet>

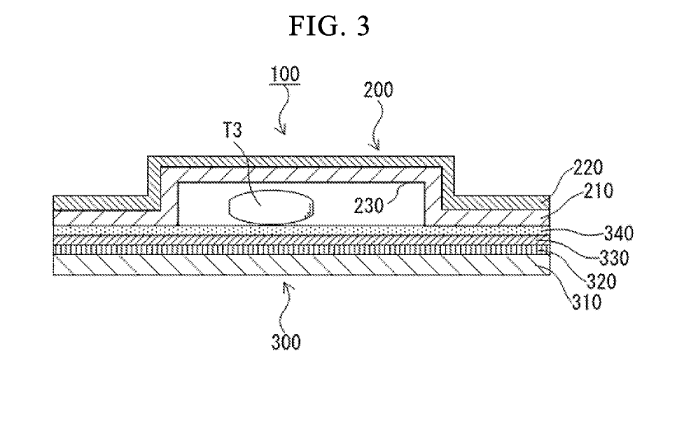

As shown in FIGS. 1 and 3, the main body sheet 200 is mainly configured of a base layer 210 and a barrier layer 220, and has a plurality of recessed sections 230. In addition, it is preferable that the main body sheet 200 have transparency. The main body sheet 200 which is heat sealed with the sealing member 300 is in close contact with the sealing member 300 in the base layer 210 side.

Here, as the aforementioned transparency, although it may suffice if the degree of transparency is such that the sealing member 300 is visible through the main body sheet 200, it is more preferable that the total light transmittance as measured in accordance with JIS K 7361 be 80% or more and also the haze value be 30% or less.

It should be noted that the main body sheet 200 may be constituted only of the base layer 210 having a barrier property to specific gas and/or light without including the barrier layer 220.

The thickness of the main body sheet 200 is preferably not less than 30 μm and not more than 800 μm, more preferably not less than 50 μm and not more than 600 μm, and most preferably not less than 100 μm and not more than 400 μm. When the thickness of the main body sheet 200 is 30 μm or more, the recessed section 230 is less likely to collapse or be torn, and also the barrier property of the main body sheet 200 improves. In addition, when the thickness of the main body sheet 200 is 800 μm or less, the transparency of the main body sheet 200 improves.

As the material of the base layer 210, for example, various resins such as polyethylene-based resins, polypropylene-based resins, cyclic polyolefin-based resins, fluorine-based resins, polystyrene-based resins, acrylonitrile-styrene (AS) copolymer resins, acrylonitrile-butadiene-styrene (ABS) copolymer resins, polyvinyl chloride resins, poly(meth)acrylic resins, polycarbonate-based resins, polyethylene terephthalate resins, polyester-based resins such as polyethylene naphthalate resins, polyamide-based resins such as various nylons, polyimide-based resins, polyamideimide-based resins, polyaryl phthalate-based resins, silicone-based resins, polysulfone-based resins, polyphenylene sulfide-based resins, polyether sulfone-based resins, polyurethane-based resins, acetal-based resins, and cellulose-based resins are used. These resins may be used alone, or may be used by copolymerizing a plurality of types thereof, or may be used by blending a plurality of types thereof, or may be used by preparing a multi-layered product. The thickness of the base layer 210 is preferably not less than 30 μm and not more than 800 μm. By applying such materials and/or thickness, it is possible to prevent the collapse of the recessed section 230 or unexpected fracture of the main body sheet 200, and also the transparency and flexibility of the main body sheet 200 tend not to deteriorate.

A resin that forms the base layer 210 may also contain additives such as antioxidants, ultraviolet absorbers, light stabilizers, lubricants, anti-blocking agents, antistatic agents, surfactants, dyes, pigments, flame retardants, plasticizers, and crystal nucleating agents, within a range so that the scope and spirit of the present invention are not impaired.

The barrier layer 220 limits the transmission of at least one of the specific gas and light that enters from the outside of the tablet packaging body 100. For this reason, the tablet packaging body 100 is capable of preventing the deterioration of the drugs T1 to T3 due to moisture and ultraviolet rays and the like, and the drugs T1 to T3 can be stored for a long period of time. The specific gas is a gas that adversely affects the drugs T1 to T3, for example, water vapor and oxygen and the like. Specifically, the light is ultraviolet light and the like.

As the material of the barrier layer 220 that is intended to be a barrier for water vapor as a specific gas, for example, metal foils such as an aluminum foil, vapor-deposited film layers of an organic silicon compound or metal oxide, and resins having a water barrier property such as a fluororesin, polyvinylidene chloride, a polytrifluoroethylene chloride resin, and a cyclic polyolefin are used.

Further, it is preferable to knead silica gel, zeolites, and alum into that resin as a material for absorbing water vapor. As a result, it is possible not only to block the water vapor from the outside, but also to remove the moisture inside the package.

The water vapor transmission rate according to the main body sheet 200 having this barrier layer 220 is preferably not greater than 10 g/m²·24 h, and more preferably not greater than 5 g/m²·24 h. It should be noted that the measurement of the water vapor transmission rate of the main body sheet 200 is performed by measuring the water vapor transmission rate of a sheet that serves as the material for the main body sheet 200 (hereinafter, referred to as “material sheet”) in accordance with JIS Z 0208. The thickness of the material sheet is the same as the thickness of the main body sheet 200 before the formation of the recessed section 230.

As the material of the barrier layer 220 that is intended to be a barrier for oxygen as a specific gas, for example, metal foils such as an aluminum foil, vapor-deposited film layers of an organic silicon compound or metal oxide, polyvinylidene chloride, polyvinyl alcohols, saponified products of ethylene-vinyl acetate copolymer (ethylene-polyvinyl alcohol copolymers) or the like are used.

In addition, as a material that absorbs oxygen, those obtained by adding a metal halide as a reaction accelerator if necessary to an inorganic compound such as reduced iron and sulfites; and those obtained by adding a transition metal catalyst (such as a cobalt salt) as a reaction accelerator if necessary to an organic compound such as ascorbic acid, MXD6 nylon, double bond-based polymers (such as unsaturated polyolefin-based resins) and polymers having a cyclohexene group can be used. As a result, it is possible not only to block the oxygen from the outside, but also to remove the oxygen inside the package.

The oxygen transmission rate according to the main body sheet 200 having this barrier layer 220 is preferably not greater than 10 cm³/m²·24 h·atm, and more preferably not greater than 1 cm³/m²·24 h·atm. It should be noted that the measurement of the oxygen transmission rate of the main body sheet 200 is performed by measuring the oxygen transmission rate of the material sheet in accordance with JIS K 7126 B. The thickness of the material sheet is the same as the thickness of the main body sheet 200 before the formation of the recessed section 230.

As the material of the barrier layer 220 that is intended to be a barrier for ultraviolet light, for example, a resin thin film containing an ultraviolet absorber or pigment and the like are used. The 90% absorption wavelength of the light transmittance curve according to the main body sheet 200 having this barrier layer 220 is preferably not greater than 600 nm. It should be noted that the measurement of the 90% absorption wavelength of the light transmittance curve of the main body sheet 200 is performed by measuring the 90% absorption wavelength of the light transmittance curve of the material sheet of the main body sheet 200 with an ultraviolet-visible spectrophotometer (manufactured by JASCO Corporation, product name: V-650). The thickness of the material sheet is the same as the thickness of the main body sheet 200 before the formation of the recessed section 230.

As the material of the barrier layer 220 that serves as a barrier for the specific gas and light, for example, those obtained by forming a vapor-deposited thin film layer made of an inorganic oxide such as aluminum oxide, silicon oxide, magnesium oxide, or a mixture thereof on a transparent resin film are used. Note that in the barrier layer 220, if necessary, a transparent primer layer may be formed on the transparent resin film, or a gas barrier coating film layer may be formed on the vapor-deposited thin film layer.

When the barrier layer 220 is a resin layer, the thickness of the barrier layer 220 is preferably not less than 30 μm, more preferably not less than 50 μm, and is also preferably not greater than 800 μm, more preferably not greater than 500 μm, and even more preferably not greater than 100 μm. In addition, when the barrier layer 220 is a vapor-deposited film layer of an organic silicon compound, metal or metal oxide, the thickness of the barrier layer 220 is preferably at least 0.5 nm and not greater than 400 nm.

The recessed section 230 is a container-like part having an internal space capable of housing the drugs T1 to T3 which corresponds to the base material. It has a shape and size that correspond with the number, type, size, and the like of the drugs T1 to T3 to be accommodated, and it is formed, for example, in a cylindrical shape with a size of 20 mm in diameter and 10 mm in depth, or in a prismatic shape with a size of 30 mm in the lengthwise direction and 30 mm in the widthwise direction and 4.5 mm in depth. However, the recessed section 230 preferably has a diameter or length in the widthwise (lengthwise) direction of 35 mm or more, from the viewpoint of preventing accidental ingestion of the recessed section 230 that is isolated as one section, as a result of which the drug management becomes easier in some cases.

The drugs T1 to T3 that a patient takes at a time are accommodated in the internal space of one recessed section 230. That is, the drugs T1 to T3 are incorporated into one package by being accommodated in the recessed section 230. As a result, it is possible to prevent the patient from taking the wrong number or type of drugs.

As the recessed section 230, three types were formed, each for morning, for daytime, and for nighttime (see FIG. 1). For example, in the recessed section 230 for morning, one drug T1 and two drugs T2 that a patient takes at a time in the morning are housed. In the recessed section 230 for daytime, one drug T3 that a patient takes at a time in the daytime is housed. In the recessed section 230 for nighttime, one each of drugs T1, T2, and T3 that a patient takes at a time in the nighttime is housed.

As shown in FIG. 1, on the upper part of the surface of the tablet packaging body 100, characters for “morning”, “daytime” and “nighttime” representing the time of day are described along the lateral direction W. Note that other descriptions such as “at bedtime” may be added in accordance with the prescription. In addition, in the left part of the surface of the tablet packaging body 100, characters for “Monday” to “Sunday” representing the days of the week and characters “1/1” to “1/7” representing the date are described along the longitudinal direction H. The recessed sections 230 are arranged in a row of three along the lateral direction W and in a row of seven along the longitudinal direction H so as to correspond with these descriptions of the day of the week, the time of day, and the date. The characters for the day of the week, the time of day, and the date on the surface of the tablet packaging body 100 are printed on the surface of the sealing member 300, and can be viewed through the main body sheet 200 having transparency.

The material sheet of the main body sheet 200 is formed through, for example, T-die extrusion molding, inflation extrusion molding, or the like. The recessed section 230 is formed, for example, by hot pressing the material sheet of the main body sheet 200 with a heated press machine. In addition, sealing of the main body sheet 200 and the sealing member 300 is performed, for example, by heat sealing the sealing member 300 to the main body sheet 200 in which the drugs T1 to T3 are housed, using a sealing machine. By this heat sealing of the main body sheet 200 and the sealing member 300, the opening of the recessed section 230 is covered with the sealing member 300, thereby sealing the internal space of the recessed section 230.

### <Sealing Member>

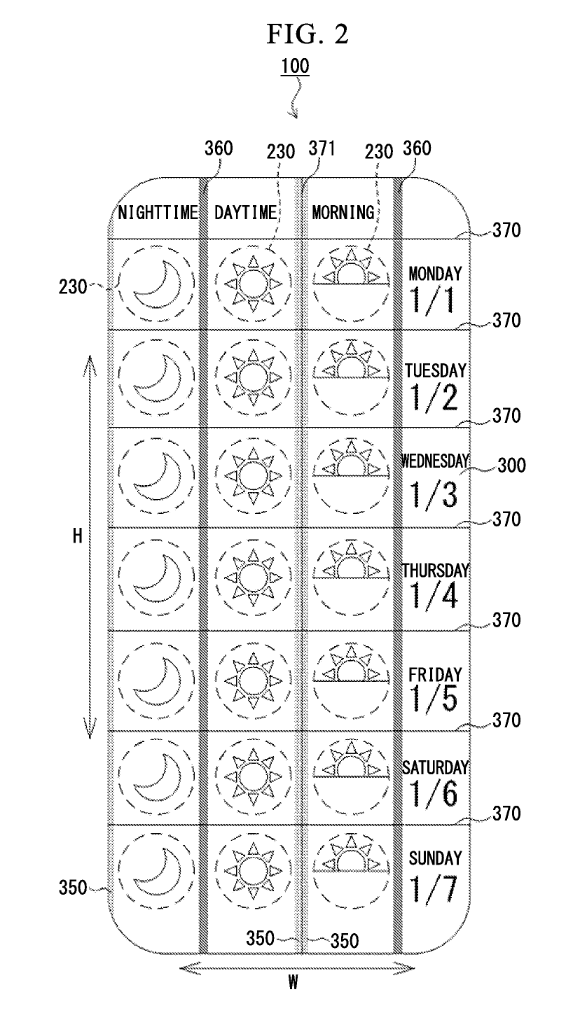

The sealing member is a portion that is peeled off upon opening the tablet packaging body and corresponds to the lid material of the tablet packaging body. As shown in FIGS. 2 and 3, the sealing member 300 mainly comprises a base material layer 310 and an easily peelable layer 330, and preferably constituted of the base material layer 310, an adhesive layer 320, the easily peelable layer 330, and a heat seal layer 340. More preferably, each of the layers 310, 320, 330, and 340 is laminated in this order. The sealing member 300 comprises a turning portion 350, a strong seal portion (release stopping portion) 360, and a slit 370 (see FIG. 2). In addition, the sealing member 300 which is heat sealed to the main body sheet 200 is in close contact with the main body sheet 200 in the heat seal layer 340 side, and can be easily peeled off from the main body sheet 200. Further, the sealing member 300 preferably has a barrier property to a specific gas (for example, water vapor, oxygen, or the like) and/or light.

The base material layer 310 is formed from, for example, resins such as polyethylene terephthalate, polybutylene terephthalate, polyethylene naphthalate, nylon 6, nylon 66, polyethylene, polypropylene, polymethylpentene, polyvinyl chloride, polyacrylate, polymethacrylate, polyimide, polyether imide, polyarylate, polysulfone, polyether sulfone, polyphenylene ether, polycarbonate, and ABS resin. These resins may be used alone, or may be used by copolymerizing a plurality of types thereof, or may be used by blending a plurality of types thereof. When improving the mechanical strength of the base material layer 310, the base material layer 310 is preferably formed from a resin such as polyethylene terephthalate, nylon 6, and nylon 66.

For the material of the base material layer 310, in order to enhance the mechanical strength of the tablet packaging body 100, a film which is stretched in the uniaxial or biaxial direction is preferred. The thickness of the base material layer 310 is preferably not less than 12 μm and not more than 200 μm, more preferably not less than 16 μm and not more than 100 μm, and most preferably not less than 20 μm and not more than 50 μm. The base material layer 310 is formed by calendar molding, T-die extrusion molding, inflation extrusion molding, or the like.

The adhesive layer 320 is preferably formed of a known adhesive resin which is used as a film adhesive for bonding the adherends such as films. In the case of a one-liquid type adhesive resin, as the material of the adhesive resin, specific examples include ester-based resins and ether-based resins. In the case of a two-liquid type adhesive resin, as the main component of the adhesive resin, ester-based resins or ether-based resins may be used, although ester-based resins are preferred. Examples of the curing agent for the adhesive resin include aromatic curing agents and aliphatic curing agents. In addition, the adhesive resin is often handled using a solvent, and is preferably a non-aqueous resin when being added to the solvent for use. From the viewpoints of ease of processing and of low cost, the adhesive layer 320 is formed on the base material layer 310 by a coating method or the like.

In addition, the easily peelable layer according to the present embodiment may be of any type among the interface peelable type which is peeled from the interface between the recessed section and the sealing member, the transfer peelable type which is peeled between the adjacent layers, and the cohesion peelable type which is peeled due to cohesive failure, although an interlayer peeling type is preferred since the transparency, sealing performance, and easy-opening property can be adjusted with good balance. For example, the function of easy peelability of the cohesion peelable type can be imparted by mixing an ethylene-vinyl acetate copolymer (EVA) resin, an ethylene-methyl methacrylate copolymer (EMMA) resin, an ethylene-ethyl acrylate copolymer (EEA) resin, an ethylene-methyl acrylate copolymer (EMA) resin, an ethylene-acrylate copolymer (EAA) resin, an ethylene-methacrylic acid copolymer (EMAA) resin, an ionomer (ION) resin, a low density polyethylene (LDPE) resin, a linear low density polyethylene (LLDPE), or the like with a polypropylene (PP) resin. The PP resin used herein may be any type of a homopolymer of polypropylene, a random copolymer of propylene-ethylene, and a block copolymer of propylene-ethylene. In addition, the easily peelable layer may be included in the recessed section.

The easily peelable layer 330 is composed of at least one layer, and plays a role as a cushion layer when the sealing member 300 is heat-sealed to the main body sheet 200 (thermal fusion bonding). In addition, the easy release property when the sealing member 300 is peeled from the main body sheet 200 (easy peeling property) can be provided by the configuration of the easily peelable layer 330.

When the easily peelable layer 330 is a transfer peelable type layer, peeling initially occurs between the easily peelable layer 330 and the adhesive layer 320, and as the peeling progresses, the easily peelable layer 330 is ruptured and transferred to the adhesive layer 320, thereby opening the recessed section 230. In this case, the easily peelable layer 330 includes a layer in consideration of compatibility with the adhesive layer 320. As the material for this type of easily peelable layer 330, low cost materials that are also easily transferred to the adhesive layer 320 are used, and the materials composed of olefin-based resins or elastomer-based resins are preferably used. When using an olefin-based resin as the material for the easily peelable layer 330, a polyethylene-based resin is preferred from the viewpoint of cushioning properties, and low density polyethylene is particularly preferable from the viewpoint of low-temperature sealability. On the other hand, when using an elastomer-based resin, a styrene-based elastomer or an olefin-based elastomer is preferred.

When the easily peelable layer 330 is a cohesive failure peelable type layer, the recessed section 230 is opened due to cohesive failure inside the easily peelable layer 330. As a main component of this type of easily peelable layer 330, olefin-based resins or the like such as polyethylene can be used, and resins or the like obtained by mixing an ethylene-vinyl acetate copolymer (EVA) resin, an ethylene-methyl methacrylate copolymer (EMMA) resin, an ethylene-ethyl acrylate copolymer (EEA) resin, an ethylene-methyl acrylate copolymer (EMA) resin, an ethylene-acrylate copolymer (EAA) resin, an ethylene-methacrylic acid copolymer (EMAA) resin, an ionomer (ION) resin, a low density polyethylene (LDPE) resin, a linear low density polyethylene (LLDPE), or the like with a polypropylene (PP) resin are preferably used. The PP resin used herein may be any type of a homopolymer of polypropylene, a random copolymer of propylene-ethylene, and a block copolymer of propylene-ethylene.

In addition, in order to easily cause cohesive failure, in the material for the easily peelable layer 330, it is preferable to mix an accessory component which is hardly compatible with the main component described above. As such an accessory component, styrene-based resins, for example, polystyrene, polyacrylic styrene or the like are used.

When the easily peelable layer 330 is an interface peelable type layer, peeling proceeds at the interface between the easily peelable layer 330 and the recessed section 230, thereby opening the recessed section 230. As the material for this type of easily peelable layer 330, those components as described above can be mentioned, although those having relatively low compatibility with a material of the counterpart member to be bonded together (recessed section or sealing member) are used from the viewpoint of easy peelability.

From the viewpoint of easy implementation at low cost, the easily peelable layer 330 is formed on the adhesive layer 320 by a dry lamination method, a co-extrusion method, an extrusion lamination method, or the like.

From the viewpoints of heat transfer and peel strength at the time of heat sealing, the thickness of the easily peelable layer 330 is preferably not less than 5 μm and not greater than 100 μm.

As the material for the heat seal layer 340, an acrylic resin, a polyester-based resin or the like is used. The heat seal layer 340 is formed on the easily peelable layer 330 by a gravure coating method or the like.

As shown in FIG. 2, the turning portion 350 is a part that is pinched when peeling the sealing member 300 from the main body sheet 200, as a result of which the sealing member 300 can be peeled off more easily from the main body sheet 200. When the sealing member 300 is heat sealed to the main body sheet 200, a part to become the turning portion 350 (a light gray portion in FIG. 2) is not heat-sealed, thereby forming the turning portion 350.

The turning portion 350 is provided, for example, on at least one end of the main body sheet 200, and is further provided between the adjacent recessed sections 230 and 230 and at a position so as to face the strong seal portion 360 through each recessed section 230. More specifically, in plan view, the turning portion 350 is formed, along the longitudinal direction H, in the left part of the recessed section 230 for nighttime and between the recessed section 230 for morning and the recessed section 230 for daytime.

When the sealing member 300 is peeled off from the main body sheet 200, the strong seal portion (release stopping portion) 360 stops the release of the sealing member 300 at an appropriate position. By adjusting the temperature, pressure, and heating time of the heat sealing process or the like, a part to become the strong seal portion 360 (a dark gray portion in FIG. 2) is sealed more strongly to the main body sheet 200 than other parts (portions of the seal member 300 excluding the strong seal portion 360), thereby forming the strong seal portion 360. For this reason, the strong seal portion 360 does not easily separate from the main body sheet 200. In addition, the strong seal portion 360 is provided between the adjacent recessed sections 230 and 230 and at a position so as to face the turning portion 350 through the recessed section 230, and more specifically, in the plan view of FIG. 2, is formed, along the longitudinal direction H, between the recessed section 230 for daytime and the recessed section 230 for nighttime and between the description of the day of the week and the recessed section 230 for morning.

The slits 370 and 371 are, for example, notches that are formed in the sealing member 300 by using a slitting device, which makes it possible to separate the sealing member 300 more easily from the main body sheet 200. The slits 370 are formed between the adjacent recessed sections 230 and 230, and the adjacent slits 370 and 370 are formed so as to face each other through the recessed section 230. More specifically, in the plan view of FIG. 2, along the lateral direction W, the slits 370 are formed between all of the recessed sections 230 and between the description of the time of day displayed in letters and the recessed section 230. The slit 371 is formed so as to be perpendicular to the slit 370. More specifically, in the plan view of FIG. 2, along the longitudinal direction H, the slit 371 is formed so as to divide the turning portion 350 in half which is located between the recessed section 230 for morning and the recessed section 230 for daytime.

A patient can peel off the sealing member 300 along the slit 370, and can also stop the peeling at the strong seal portion 360. For this reason, in the tablet packaging body 100, a patient can open only the desired recessed section 230. In addition, since the sealing member 300 is not separated from the main body sheet 200 when opening the recessed section 230, it is preferable from the viewpoint of preventing accidental ingestion.

As described above, the day of the week, time of day and date are printed on the surface of the sealing member 300 (see FIG. 1). In addition, as shown in FIG. 2, also on the upper part of the back surface of the sealing member 300, characters for “morning”, “daytime” and “nighttime” representing the time of day are printed along the lateral direction W. In the right part of the back surface of the sealing member 300, characters for “Monday” to “Sunday” representing the days of the week and characters “1/1” to “1/7” representing the date are printed along the longitudinal direction H. In the part covering the recessed section 230 on the back surface of the sealing member 300, pictures for “morning”, “daytime” and “nighttime” representing the time of day for taking the drugs T1 to T3 accommodated in each of the recessed sections 230 are printed.

### <Flow of Supply of Tablet Packaging Body>

(First Case)

A manufacturer of tablet packaging bodies supplies the produced material sheet of the main body sheet 200 to a packaging machine manufacturer. The packaging machine manufacturer supplies the material sheet of the main body sheet 200, the sealing member 300, a sealing machine, and a hot press machine to hospitals, dispensing pharmacies, or the like. The hospitals, dispensing pharmacies, or the like form the recessed section 230 by hot-pressing the material sheet of the main body sheet 200 with a hot press machine, thereby obtaining the main body sheet 200. Then, the hospitals, dispensing pharmacies, or the like heat seal the sealing member 300 to the main body sheet 200 that houses the drugs T1 to T3 with a sealing machine, thereby obtaining the tablet packaging body 100. Note that the packaging machine manufacturer may form the main body sheet 200 and supply the main body sheet 200, the sealing member 300, and the sealing machine to the hospitals, dispensing pharmacies, or the like.

(Second Case)

A manufacturer of tablet packaging bodies directly supplies the produced material sheet of the main body sheet 200 to hospitals, dispensing pharmacies, or the like. A packaging machine manufacturer supplies the sealing member 300, a sealing machine, and a hot press machine to hospitals, dispensing pharmacies, or the like. The hospitals, dispensing pharmacies, or the like form the recessed section 230 by hot-pressing the material sheet of the main body sheet 200 with a hot press machine, thereby obtaining the main body sheet 200. Then, the hospitals, dispensing pharmacies, or the like heat seal the sealing member 300 to the main body sheet 200 that houses the drugs T1 to T3 with a sealing machine, thereby obtaining the tablet packaging body 100. Note that the manufacturer of tablet packaging bodies rather than the packaging machine manufacturer may directly supply the sealing member 300 to the hospitals, dispensing pharmacies, or the like.

(Third Case)

A manufacturer of tablet packaging bodies supplies the produced main body sheet 200 and the sealing member 300 to a packaging machine manufacturer. The packaging machine manufacturer supplies a sealing machine to hospitals, dispensing pharmacies, or the like. The hospitals, dispensing pharmacies, or the like heat seal the sealing member 300 to the main body sheet 200 that houses the drugs T1 to T3 with a sealing machine, thereby obtaining the tablet packaging body 100. Note that the packaging machine manufacturer rather than the manufacturer of tablet packaging bodies may supply the sealing member 300 to the hospitals, dispensing pharmacies, or the like.

(Fourth Case)

A manufacturer of tablet packaging bodies supplies the produced main body sheet 200, the sealing member 300, and a sealing machine to the hospitals, dispensing pharmacies, or the like. The hospitals, dispensing pharmacies, or the like heat seal the sealing member 300 to the main body sheet 200 that houses the drugs T1 to T3 with a sealing machine, thereby obtaining the tablet packaging body 100.

The hospitals and dispensing pharmacies as described above in the first to fourth cases can also be, for example, a pharmaceutical manufacturer or a food manufacturer.

### <Effects in the First Embodiment>

By accommodating a plurality of drugs T1 to T3 in one recessed section 230, the tablet packaging body 100 enables the incorporation of drugs T1 to T3 into one package. In addition, in those cases where the aforementioned main body sheet 200 and/or the aforementioned sealing member 300 has a barrier property to limit the transmission of at least one of specific gas and light entering from the outside, the tablet packaging body 100 is capable of suppressing deterioration of the drugs T1 to T3 during storage. For this reason, the tablet packaging body 100 is capable of storing the drugs T1 to T3 for a long period of time.

In the tablet packaging body 100, the sealing member 300 is sealed to the main body sheet 200 so as to be easily peelable from the main body sheet 200. For this reason, an elderly or crippled patient can easily take out the drugs T1 to T3 from the tablet packaging body 100.

When at least one of the day of the week, time of day and date for taking the drugs T1 to T3 housed in the recessed section 230 is described on the tablet packaging body 100, it is difficult for the patient to take drugs T1 to T3 at a wrong time. In addition, in the tablet packaging body 100, doctors, pharmacists, nurses, patient's family, caregivers and the like can confirm whether or not a patient (drug recipient) has taken the drugs T1 to T3 by checking the description of the characters for the date or the like that corresponds with the empty recessed section 230, and can also check the time the patient has taken the drugs T1 to T3.

When the thickness of the main body sheet 200 is not less than 30 μm and not more than 800 μm, the main body sheet 200 exhibits favorable rigidity. For this reason, the tablet packaging body 100 is less likely to be damaged by an external force. Thus, the tablet packaging body 100 can be put into a pocket, bag or the like and carried as it is without using a protective cover or the like to prevent breakage of the tablet packaging body 100, which results in excellent usability.

In those cases where the aforementioned main body sheet 200 and/or the aforementioned sealing member 300 has transparency, the drugs T1 to T3 accommodated in the tablet packaging body 100 can be visually recognized. Therefore, the tablet packaging body 100 suppresses the occurrence of mistakes in passing the drugs T1 to T3 in hospitals, dispensing pharmacies, or the like.

### Modified Example

### A1

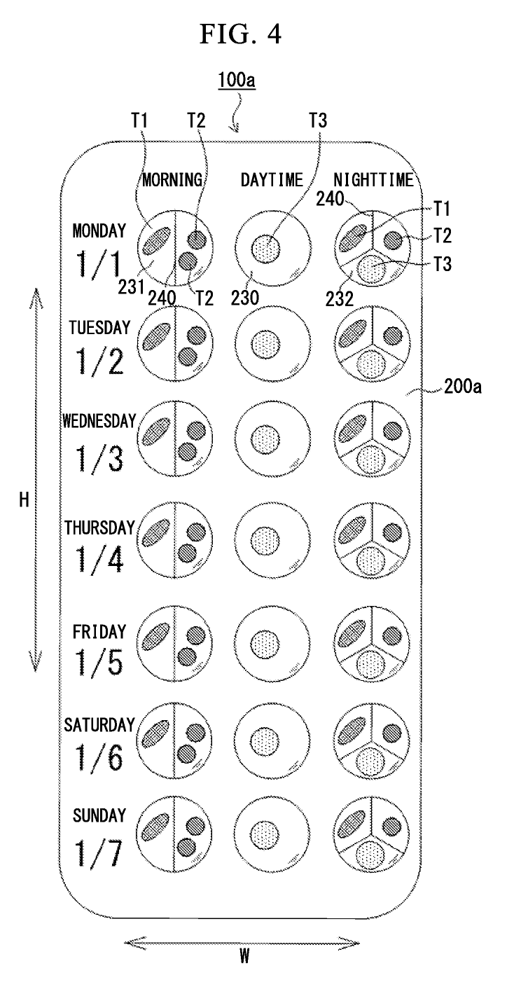

As shown in FIG. 4, a main body sheet 200a of a tablet packaging body (packaging sheet) 100a may have recessed sections 231 and 232 having a plurality of compartments separated by a separator unit 240. The recessed section 231 has two compartments; a compartment for housing one T1 drug and a compartment for housing two T2 drugs. The recessed section 232 has three compartments; a compartment for housing one T1 drug, a compartment for housing one T2 drug and a compartment for housing one T3 drug. It should be noted that the separator unit 240 of the recessed sections 231 and 232 may or may not be heat sealed to the sealing member 300.

The tablet packaging body 100a can respectively accommodate different types of drugs T1 to T3 in each compartment. For this reason, the tablet packaging body 100a prevents the different types of drugs T1 to T3 from directly contacting and reacting with each other. Therefore, the tablet packaging body 100a suppresses deterioration of the drugs T1 to T3 during storage.

### B1

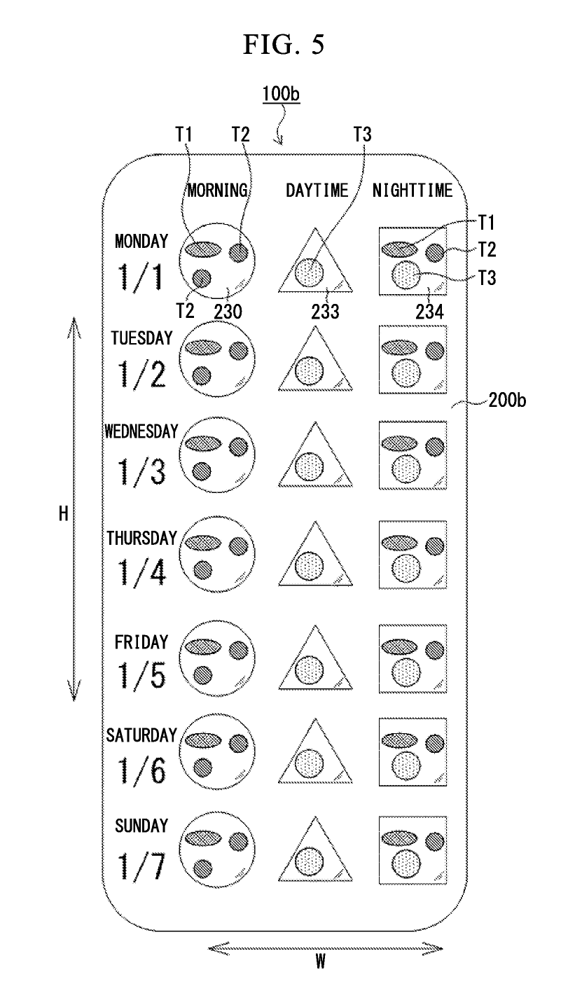

As shown in FIG. 5, in plan view, a main body sheet 200b of a tablet packaging body (packaging sheet) 100b may have a recessed section 230 for morning having a round shape, a recessed section 233 for daytime having a triangular shape, and a recessed section 234 for nighttime having a quadrangular shape. In the tablet packaging body 100b, the shape of each of the recessed sections 230, 233 and 234 is different. For this reason, it is easier for a patient to check the time for taking the drugs T1 to T3.

### C1

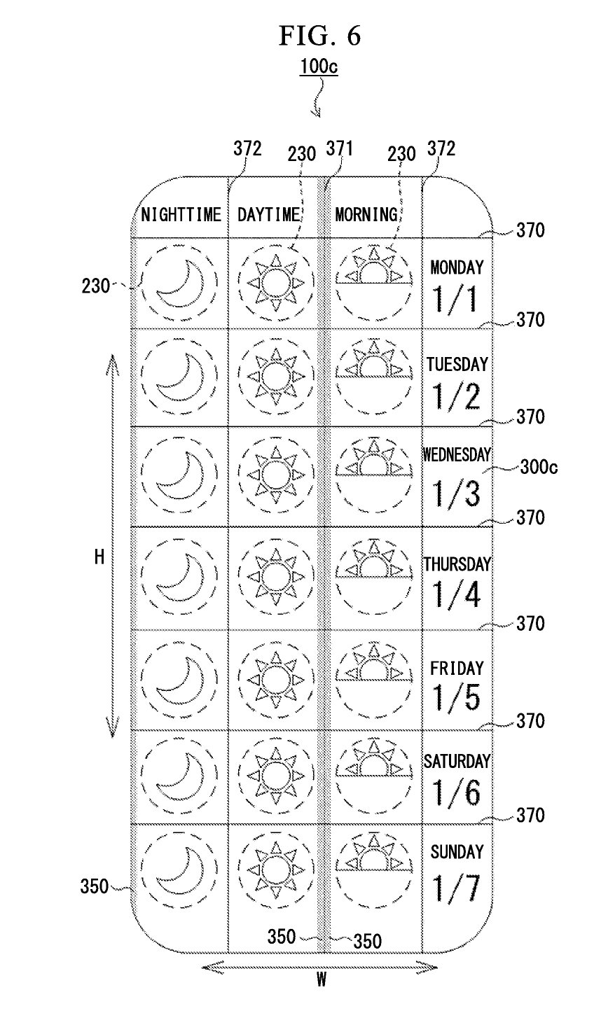

As shown in FIG. 6, a sealing member 300c of a tablet packaging body 100c may have, instead of the strong seal portion 360, a slit 372 which is a notch formed along the longitudinal direction H so as to be perpendicular to the slit 370 and to face the slit 371 through the recessed section 230. In plan view, the slit 372 is formed between the recessed section 230 for daytime and the recessed section 230 for nighttime and between the description of the days of the week and the recessed section 230 for morning. By providing the slits 370, 371, and 372 around each of the recessed sections 230, the sealing member 300c is divided so as to correspond to each of the recessed sections 230 (per each recessed section 230).

A patient can release the sealing member 300c along the slit 370 and can also remove, from the tablet packaging body 100c by the slit 372, the sealing member 300c which has been released. For this reason, in the tablet packaging body 100c, a patient can open only the desired recessed section 230.

### D1

The sealing member 300 may be formed of two layers composed of the base material layer 310 and the heat seal layer 340 without having the adhesive layer 320 and the easily peelable layer 330.

### E1

In the tablet packaging body 100, the number of recessed sections 230 may be one. In addition, any number of recessed sections 230 may be disposed, each along the lateral direction W and the longitudinal direction H, as long as they are made to correspond with the description of the day of the week or the like in the tablet packaging body 100.

### F1

In the tablet packaging body 100, the number of drugs T1 to T3 accommodated in one recessed section 230 is plural. In addition, the type of drugs T1 to T3 accommodated in one recessed section 230 may be one type or may be two or more types. Further, the drugs T1 to T3 may be in the forms of capsules, pills, granules or the like, instead of tablets.

### G1

It is sufficient if at least one of the day of the week, time of day and date for taking the drugs T1 to T3 is described on the tablet packaging body 100 so as to correspond with the recessed section 230. In addition, it is sufficient if the day of the week or the like for taking the drugs T1 to T3 accommodated in the recessed section 230 is described on at least one of the main body sheet 200 and the sealing member 300.

### H1

In the tablet packaging body 100, it is sufficient if at least one of the main body sheet 200 and the sealing member 300 has a barrier property with respect to at least one of specific gas and light, but it is more preferable that both of the main body sheet 200 and the sealing member 300 have a barrier property against both of specific gas and light. In addition, it is sufficient if at least one of the main body sheet 200 and the sealing member 300 has transparency, but it is more preferable that at least the main body sheet 200 have transparency.

### I1

Instead of the sealing member 300, the main body sheet 200 may have layers required for heat sealing such as the adhesive layer 320, the easily peelable layer 330, and the heat seal layer 340. In this case, the main body sheet 200 is heat sealed to the sealing member 300.

### J

The packaging sheet 100 may be one to take out the drugs T1 to T3 after breaking through the sealing member 300, in place of one to take out the drugs T1 to T3 after easily peeling off the sealing member 300 from the main body sheet 200.

Next, a tablet packaging body according to a second embodiment of the present invention will be described, although for the same configurations as those of the aforementioned tablet packaging body according to the first embodiment, description thereof will be omitted.

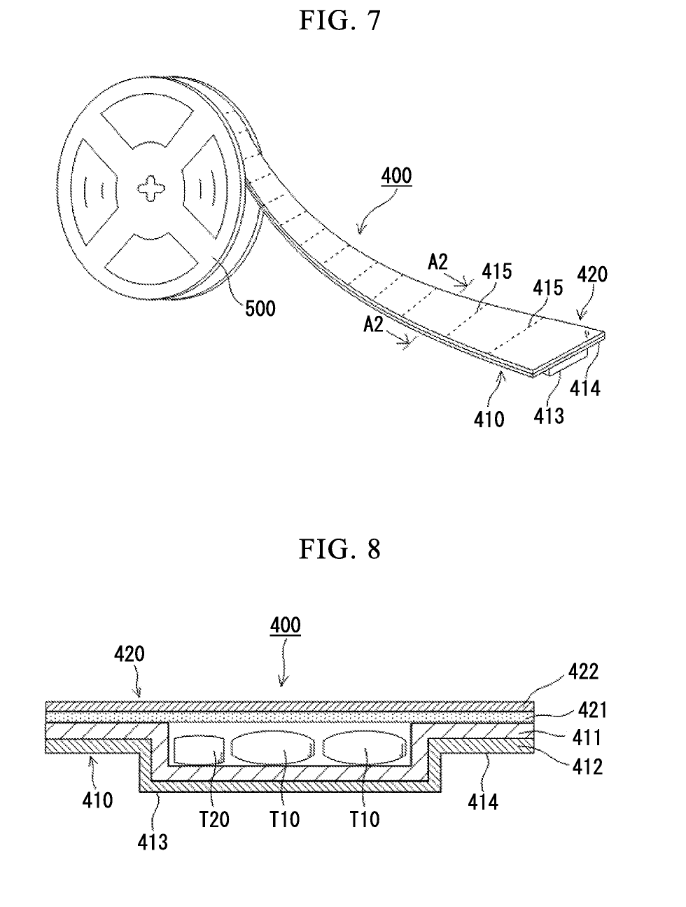

In the present embodiment, as shown in FIGS. 7 to 9, a tablet packaging body (packaging sheet) 400 is mainly constituted of a main body sheet 410 and a sealing member 420. Each component of the tablet packaging body 400 will be described in detail below.

### <Main Body Sheet>

The main body sheet 410 is a strip-like sheet that can be rolled into a roll, that is, a long sheet with a certain width, and can be rolled and stacked up into a hollow cylindrical shape.

Since the tablet packaging body of the present embodiment can be rolled and stacked up into a roll during storage or transport, the size of the gap is reduced, thereby saving space. For this reason, it is possible to reduce the cost at the time of storage or transport.

As with the aforementioned first embodiment, as shown in FIG. 8, the main body sheet 410 is mainly composed of the base layer 411 and the barrier layer 412. Because the base layer 411 and the barrier layer 412 are formed in the same manner as the base layer 210 and the barrier layer 220 of the aforementioned first embodiment, respectively, detailed descriptions thereof will be omitted, although it is preferable that the barrier layer 220 be a water vapor barrier layer or an oxygen barrier layer.

The thickness of the main body sheet 410 is not particularly limited, although it is preferably not less than 30 μm and not more than 800 μm, more preferably not less than 50 μm and not more than 600 μm, and most preferably not less than 100 μm and not more than 400 μm. When the thickness of the main body sheet 410 is within the above range, it is possible to prevent crushing or breakage of the recessed section 413, and it is also possible to impart good barrier properties to the main body sheet 410. On the other hand, when the thickness of the main body sheet 410 is greater than 800 μm, it tends to be difficult to roll and stack up the tablet packaging body 400 or the main body sheet 410 into a roll.

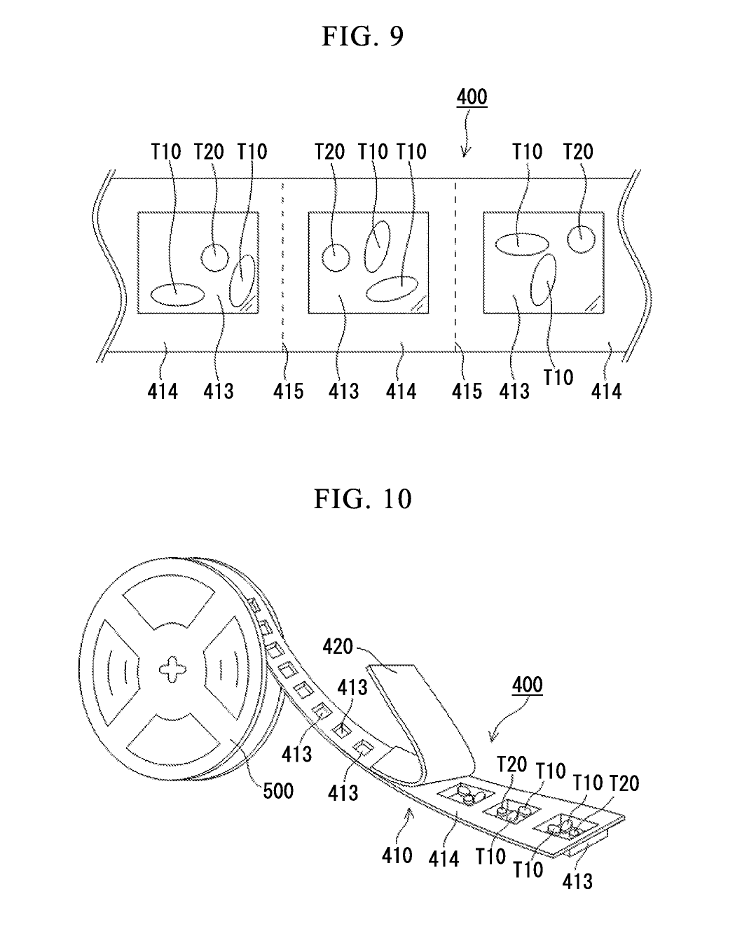

In addition, as shown in FIGS. 7 and 9, the main body sheet 410 includes a recessed section 413, a flat plate portion 414, and a slit 415.

As shown in FIGS. 7 and 8, along the longitudinal direction of the main body sheet 410, the recessed section 413 is provided in plurality in a row at equal intervals. When winding the tablet packaging body 400 without using a reel 500 to be described later, since the main body sheet 410 bends at regular intervals because a plurality of recessed sections 413 are provided successively at equal intervals, the tablet packaging body 400 can be easily wound up into a roll.

As with the aforementioned first embodiment, the recessed section 413 is formed in any shape and size depending on the number, type, and size of drugs. More specifically, for example, the recessed section 413 is formed in the form of a square tube shape having a bottom wall and with a size of 30 mm vertically, 30 mm horizontally, and 4.5 mm in depth, so as to be able to accommodate two tablets of drug T10 and one tablet of drug T20 that a patient takes at a time. In the recessed section 413, the drugs T10 and T20 are housed side by side on a flat surface of the bottom wall of the recessed section 413. It should be noted that the drug T20 may be a different type of drug from the drug T10, or may be the same type of drug. Further, the drugs T10 and T20 may be in the forms of tablets, capsules, granules or the like.

As shown in FIGS. 7 and 9, the slits 415 are provided in the flat plate portion 414 between each of the recessed sections 413. The slits 415 are perforated cuts that penetrate through the main body sheet 410 and the sealing member 420. More specifically, the slits 415 are provided by forming a plurality of notches at predetermined intervals along the width direction of the strip-like main body sheet 410. The predetermined interval is an interval designed so that the tablet packaging body 400 breaks at the intended slit 415 when an external force is applied to the tablet packaging body 400.

The interval between the slits 415 and 415 that are adjacent to each other in the longitudinal direction is appropriately set in accordance with the size of the recessed section 413.

### <Sealing Member>

As shown in FIG. 8, the sealing member 420 is mainly composed of a cohesive layer (adhesive layer) 421 and a barrier layer 422. Here, the cohesive layer 421 in the present embodiment also functions as an easily peelable layer. It is preferable that the barrier layer 422 be a water vapor barrier layer or an oxygen barrier layer. When attached to the main body sheet 410, the sealing member 420 is in close contact with the main body sheet 410 so as to cover an opening of the recessed section 413. At this time, the cohesive layer 421 of the sealing member 420 is in close contact with the base layer 411 of the main body sheet 410. The thickness of the sealing member 420 is not particularly limited, although it is preferably not less than 10 μm and not more than 1000 μm, and more preferably not less than 20 μm and not more than 500 μm.

The cohesive layer 421 is formed, for example, from resins such as low density polyethylene, medium density polyethylene, high density polyethylene, straight-chain (linear) low density polyethylene, an ethylene-α•olefin copolymer polymerized using a metallocene catalyst, polypropylene, an ethylene-vinyl acetate copolymer, an ionomer resin, an ethylene-acrylic acid copolymer, an ethylene-ethyl acrylate copolymer, an ethylene-methacrylic acid copolymer, an ethylene-methyl methacrylate copolymer, an ethylene-propylene copolymer, metal cross-linked products thereof; acid-modified polyolefin resins obtained by modifying polyolefin-based resins such as methyl pentene polymers, polybutene polymers, polyethylene and polypropylene with unsaturated carboxylic acids such as acrylic acid, methacrylic acid, maleic acid, maleic anhydride, fumaric acid, and itaconic acid; polyvinyl acetate-based resins, poly(meth)acrylic resins, and polyvinyl chloride-based resins. These resins may be used alone, or may be used by copolymerizing a plurality of types thereof, or may be used by blending a plurality of types thereof.

In a resin that forms the cohesive layer 421, additives such as antioxidants, ultraviolet absorbers, light stabilizers, lubricants, anti-blocking agents, antistatic agents, surfactants, dyes, pigments, flame retardants, plasticizers, and crystal nucleating agents may also be included within a range so that the scope and spirit of the present invention are not impaired.

In the case of adding the above-mentioned additives to a resin that forms the base layer 411 or the cohesive layer 421, known methods such as a method of using a batch-type kneading machine such as a Banbury mixer, a kneader, and a roll mill or a continuous-type kneading machine such as a single screw extruder, a twin-screw extruder and a calendar roll can be used. Among these methods, it is preferable to use a twin screw kneader equipped with a vacuum deaerator.

In addition, the main body sheet 410 and the sealing member 420 can be produced by subjecting the resins described above to a conventional method such as T-die extrusion molding, inflation extrusion molding, and calendar molding.

As with the barrier layer 412 of the main body sheet 410, the barrier layer 422 is a layer that plays a role in preventing a specific gas (for example, water vapor in the atmosphere) and light from entering the internal space of the recessed section 413. The barrier layer 422 can be formed using the same materials as those for the main body sheet 410 and the barrier layer 412. In addition, the thickness of the barrier layer 422 may be the same as the thickness of the main body sheet 410 and the barrier layer 412.

### <Production Method of Tablet Packaging Body>

The tablet packaging body 400 according to the present embodiment can be produced by using a known method for producing a PTP (Press Through Package) sheet. First, the main body sheet 410 is subjected to hot pressing using a known PTP molding apparatus. The recessed section 413 is formed in the main body sheet 410 by the hot pressing.

Next, in the internal space of the recessed section 413 of the main body sheet 410, two tablets of drug T10 and one tablet of drug T20 that a patient takes at a time are housed. Then, the sealing member 420 is heat sealed and attached to the main body sheet 410 which accommodates the drugs T10 and T20, thereby sealing the internal space of the recessed section 413. It should be noted that the number of drugs to be accommodated in the recessed section 413 is plural. In addition, the type of drug accommodated in the recessed section 413 may be one type or two or more types. As the combination of the number and type of drug accommodated in the recessed section 413, for example, a combination that can be generally formulated for a certain disease and can be taken by anyone who is a patient of the disease is preferred from the viewpoint of inventory control.

Finally, the slits 415 are formed in the main body sheet 410 and the sealing member 420 with a slitting device. Note that these series of work can be carried out in a continuous manner.

### <Storage and Transport of Tablet Packaging Body>

(When the Drug is Accommodated at the Factory)

In those cases where the drugs T10 and T20 are accommodated in the tablet packaging body 400 in a factory, the tablet packaging body 400 that received the drugs T10 and T20 in the factory is stored in a state of being wound onto the reel 500, and transported to pharmacies, hospitals, or the like (see FIG. 7). The tablet packaging body 400 is wound into a roll, as a result of which layers of tablet packaging body 400 cover each other to protect the sealing member 420, thereby making it possible to prevent the sealing member 420 from breaking. Note that the tablet packaging body 400 may be rolled and stacked up into a roll without using the reel 500.

In a pharmacy, hospital, or the like, the tablet packaging body 400 is pulled out from the reel 500, and the tablet packaging body 400 with a required number of recessed sections 413 is cut out at the slit 415 in accordance with the patient's prescription. The patient receives this tablet packaging body 400 which has been cut out and keeps it until the drug is taken. The patient takes the drugs T10 and T20 which have been removed from the tablet packaging body 400 by tearing the sealing member 420 at the time of day for taking drugs. In addition, since it is possible for the patient to cut out the tablet packaging body 400 with a required number of recessed sections 413 for carrying around at the slit 415, it becomes easy to carry around the drugs T10 and T20.

(When the Drug is Accommodated in a Pharmacy, Hospital, or the Like)

In those cases where the drugs T10 and T20 are accommodated in the tablet packaging body 400 in a pharmacy, hospital, or the like, only the main body sheet 410 is wound onto the reel 500 and stored in a factory. The main body sheet 410 which is wound onto the reel 500 is transported to pharmacies, hospitals, or the like. In addition, the sealing member 420 and the drugs T10 and T20 are transported to pharmacies, hospitals, or the like separately from the main body sheet 410.

As shown in FIG. 10, in pharmacies, hospitals, or the like, the drugs T10 and T20 are accommodated in the required number of recessed sections 413 pulled out from the reel 500. Then, the sealing member 420 is heat sealed to the part of the main body sheet 410 accommodating the drugs T10 and T20. Thereafter, the slits 415 are formed at predetermined intervals in the width direction of the strip-like main body sheet 410.

In pharmacies, hospitals, or the like, the tablet packaging body 400 accommodating the drugs T10 and T20 may be made in advance and stored as a stock, or may be made in each case in accordance with the patient's prescription.

### <Effects of the Present Embodiment>

As described above, the tablet packaging body 400 according to the present embodiment is rolled and stacked up into a roll when storing or transporting this tablet packaging body 400 in large quantity, as a result of which the size of the gap is reduced, thereby saving space. As described above, since it is possible to store or transport the tablet packaging body 400 in a reduced space, the cost at the time of storage or transport can be reduced. In addition, since the internal space of the recessed section 413 is sealed, the tablet packaging body 400 exhibits a high barrier property, and the drugs T10 and T20 can be stored for a long period of time.

Further, in the tablet packaging body 400 according to the present embodiment, when the patient is taking a plurality of drugs at the same time, since a plurality of tablets of drug T10 to be taken at a time are accommodated in one recessed section 413, it is possible to prevent the patient from taking the wrong number of tablets of drug T10. Furthermore, by performing a single operation of taking out the drug T10 from the tablet packaging body, the patient can take out a plurality of tablets of drug T10 at a time. For this reason, the patient can easily take out a plurality of tablets of drug T10 from the tablet packaging body 400.

In addition, in the tablet packaging body 400 according to the present embodiment, when the patient is taking a plurality of types of drugs at the same time, since a plurality of types of drugs T10 and T 20 to be taken at a time are accommodated in one recessed section 413, it is possible to prevent the patient from taking the wrong type of drugs T10 and T20. Furthermore, by performing a single operation of taking out the drugs T10 and T20 from the tablet packaging body 400, the patient can take out a plurality of types of drugs T10 and T20 at a time. For this reason, the patient can easily take out a plurality of types of drugs T10 and T20 from the tablet packaging body.

In addition, the tablet packaging body 400 according to the present embodiment can improve the convenience of portability and the like since it is possible to cut out the tablet packaging body 400 which is provided with the required number of recessed sections 413 by the slits 415.

### Modified Example

### A2

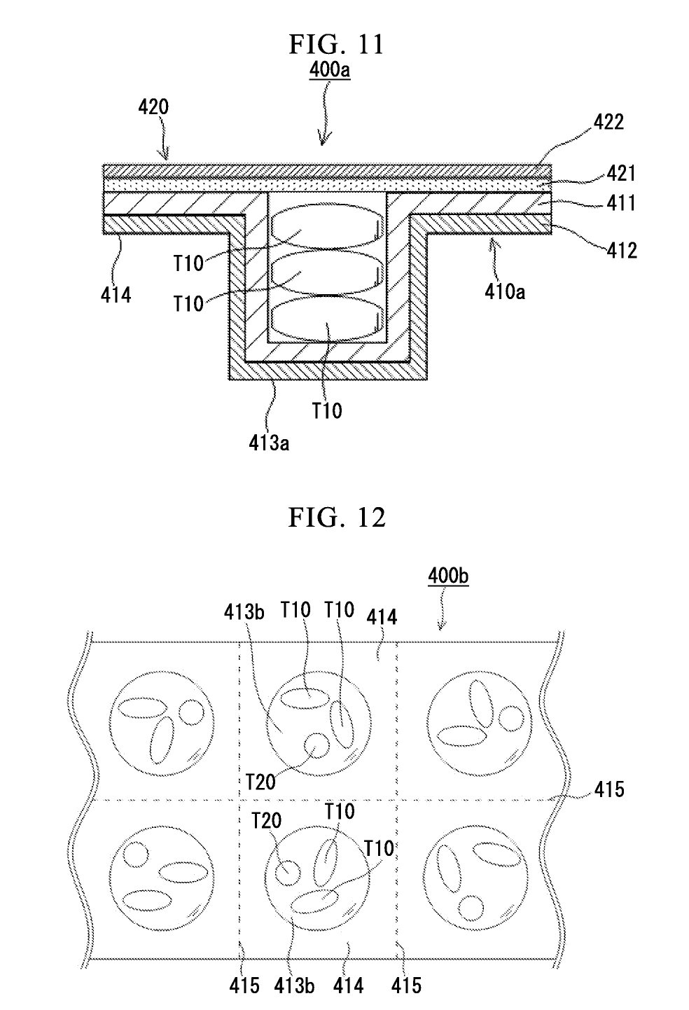

As shown in FIG. 11, in a main body sheet 410a of a tablet packaging body 400a, a recessed section 413a can be formed in a size capable of accommodating a plurality of drugs of the same type that are stacked in the depth direction. The size of the recessed section 413a is set appropriately in accordance with the size of the drug to be accommodated, although it is formed, for example, with a size of 10 mm in the lengthwise direction, 10 mm in the widthwise direction, and 13.5 mm in depth, and three tablets of drug T10 are stacked in the depth direction and accommodated in the recessed section 413a. By such a configuration, it is possible to further promote space saving at the time of packaging a plurality of drugs of the same type.

The thickness of the main body sheet 410a before the formation of the recessed section 413a is preferably, for example, not less than 90 μm and not more than 800 μm, in view of the stretch ratio at the time of forming the recessed section 413a and the barrier property of the tablet packaging body 400a.

### B2

As shown in FIG. 12, a tablet packaging body 400b may be arranged so that the recessed sections 413b are disposed in two rows in the width direction. Further, the recessed section 413b is formed in the form of a cylinder having a bottom wall, and with a size of, for example, 30 mm in diameter and 4.5 mm in depth. In addition, in the recessed section 413b, the drugs T10 and T20 are accommodated side by side on a plane of the bottom wall of the recessed section 413b.

Note that the recessed section 413b may be one formed in a triangular tube shape having a bottom wall, an elliptical cylindrical shape, or the like. In addition, the recessed sections 413b may be arranged side by side in three or more rows in the width direction of the main body sheet. At this time, the recessed section 413b may be provided so that the drugs T10 and T20 are stacked and accommodated in the depth direction of the recessed section 413b, and, for example, may be formed with a size of 10 mm in diameter and 13.5 mm in depth.

### C2

The barrier layers 412 and 422 may each have a single-layer structure or a multi-layer structure (for example, a two-layer structure composed of a water vapor barrier layer and an oxygen barrier layer). Alternatively, the main body sheet 410 may be formed only of the base layer 411 and does not have the barrier layer 412.

As the barrier layer 422, if provided with an aluminum foil having a high moisture resistance, the thickness of the sealing member 420 is preferably not less than 10 μm and not more than 50 μm.

### D2

The cohesive layer 421 may be provided on the main body sheet 410, rather than being provided on the sealing member 420. In this case, the cohesive layer 421 is disposed on the side opposite to the side where the barrier layer 412 of the base layer 411 is provided. In addition, the sealing member 420 is constituted only of the barrier layer 422.

### E2

Intervals for providing a recessed section 413 may be those that are not equally spaced, and are provided so that a narrow interval and a wide interval are arranged alternately.

### F2

The notches of the slits 415 may be those which do not penetrate the main body sheet 410, and, for example, may be those in which the depth of the cut is about half of the thickness of the main body sheet 410 (half cut), and the like.

### Third Embodiment

Next, a tablet packaging body (packaging sheet) 400c according to a third embodiment of the present invention will be described. Although the tablet packaging body 400 according to the second embodiment described above is of a PTP packaging type, this tablet packaging body 400c according to the third embodiment is different in that it is of an easily peelable packaging (easy peel packaging) type. It should be noted that the same reference numerals as those used in the second embodiment are given to the same configurations as those of the second embodiment described above, and the descriptions thereof will be omitted as appropriate.

<Sealing member>

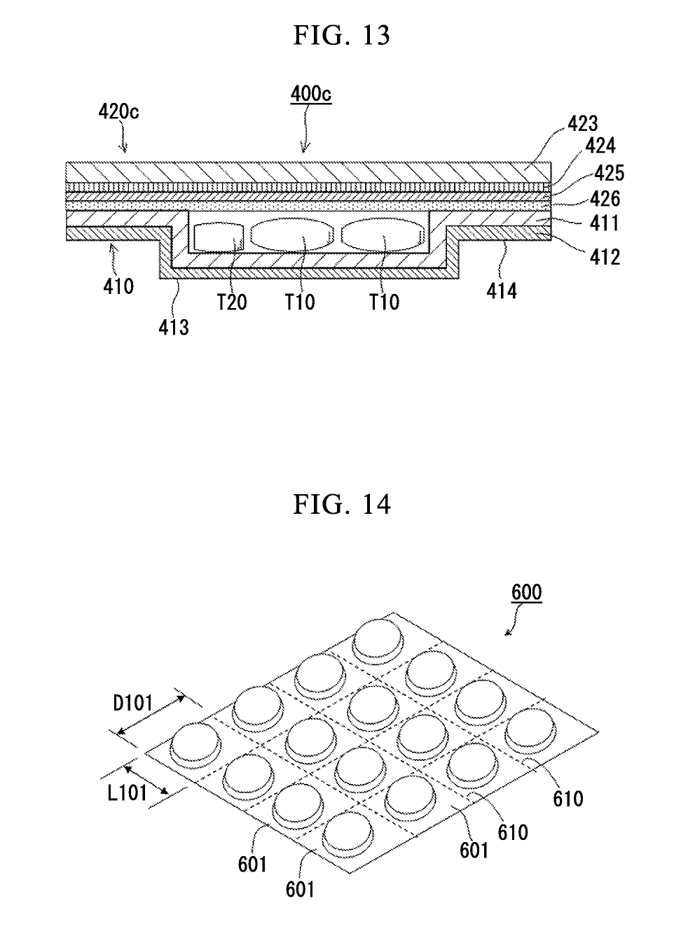

As shown in FIG. 13, a sealing member 420c of the tablet packaging body 400c mainly includes a base material layer 423 and an easily peelable layer 425, and is preferably constituted of an adhesive layer 424, the easily peelable layer 425, and a heat seal layer 426, and more preferably, the adhesive layer 424, the easily peelable layer 425, and the heat seal layer 426 are laminated in this order. Since these configurations of the sealing member 420c are each identical to the base material layer 310, the adhesive layer 320, the easily peelable layer 330, and the heat seal layer 340 of the first embodiment, the detailed descriptions thereof will be omitted.

The thickness of the base material layer 423 is preferably not less than 12 μm and not more than 30 μm, more preferably not less than 16 μm and not more than 28 μm, and particularly preferably not less than 20 μm and not more than 25 μm.

### <Production Method of Tablet Packaging Body>

The main body sheet 410 in which the recessed section 413 is formed is obtained in the same manner as in the second embodiment described above. Next, in the internal space of the recessed section 413 of the main body sheet 410, for example, the drugs T10 and T20 that a patient takes at a time are accommodated. Then, the sealing member 420c is heat sealed and attached to the main body sheet 410 which accommodates the drugs T10 and T20, thereby sealing the internal space of the recessed section 413. Finally, the slits 415 are formed in the main body sheet 410 and the sealing member 420c with a slit marking device, thereby obtaining the tablet packaging body 400c. Note that these series of work can be carried out in a continuous manner.

### <Effects of the Present Embodiment>

As described above, in the tablet packaging body 400c according to the present embodiment, because the sealing member 420c is in close contact with the main body sheet 410 so as to be easily peeled from the main body sheet 410, the patient can easily take out the drugs T10 and T20 from the tablet packaging body 400c.

### Modified Example

### A3

When the easily peelable layer 425 has a sealing function, the sealing member 420c may not have the heat seal layer 426.

By storing or transporting the tablet packaging body of the present embodiment in a state of being wound into a roll, the size of the gap is reduced, thereby saving space. For this reason, it is possible to reduce the cost at the time of storage or transport.

Hereinafter, a tablet packaging body of a fourth embodiment will be described in detail, although for the same configurations as those of the tablet packaging body of the embodiment described above, the descriptions thereof will be omitted as appropriate.

In the tablet packaging body of the fourth embodiment, the aforementioned sealing member seals the aforementioned recessed section by a line seal. Here, the line seal is a method for sealing linearly an inlet of the packaging body or an edge of an outlet by a sealing member. The method for performing line seal is not particularly limited, and examples thereof include a method of applying an adhesive to the edge portions described above, and a sealing method by making a projection in the shape of a line seal on a sealing board when sealing the sealing member by heat sealing. In the present invention, by sealing with line seals, tablets can be stored stably regardless of the surrounding environment, and the oxidation or degradation of the tablet inside the tablet packaging body can be suppressed. In addition, a sufficient capacity for packaging a plurality of tablets, capsules, supplements, or the like can be secured, and two or more types of required tablets can be taken out at a time by performing once an operation of taking out the tablets, so that it is possible to prevent the patient from taking the wrong type of drugs. On the other hand, it is possible to easily adjust the peel strength of the aforementioned sealing member by adjusting the width interval of the line seal, so that the tablets can be easily taken out even by an elderly or crippled patient.

In addition, in the aforementioned tablet packaging body, it is preferable to set the peel strength when starting to break the seal (opening start point) to be lower than the peel strength in the middle of the seal breaking (opening middle point). It is possible to peel the sealing member easily by lowering the peel strength when starting to break the seal. Therefore, it is possible even for an elderly or crippled patient or those weak in strength to reliably start the peeling of the sealing member. In addition, when breaking of a seal is started once, since it becomes easier to maintain the peeling angle and the force applied for peeling, it is possible to easily break the seal even if the peel strength in the middle of the seal breaking is higher than the peel strength at the start of the seal breaking. As a result, it is possible to take out the tablets (drugs) more easily, and it is also possible to ensure sufficient sealing properties of the tablet packaging body. Here, the peel strength at the start of opening is defined as the peel strength at the opening start portion. In addition, the peel strength at the opening start portion corresponds to the peel strength in a part of the edge of the gripping portion (turning portion) to be described later, which is also an adhesion portion of the sealing member and the recessed section to be described later, and, for example, corresponds to the peel strength in an adhesion portion 606b in FIGS. 16 to 20. On the other hand, the peel strength in the middle of opening is not particularly limited as long as it is the peel strength since the start of the opening, although it corresponds to the peel strength in the part other than the edge of the gripping portion which is in the adhesion portion of the sealing member and the recessed section to be described later, and, for example, corresponds to the peel strength in an adhesion portion 606a in FIGS. 16 to 20.

Here, the peel strength at the start of opening is preferably not less than 0.001 N and not more than 6 N, and particularly preferably not less than 0.009 N and not more than 3 N. When the peel strength is equal to or more than the lower limit described above, it is possible to sufficiently prevent the accidental opening during storage, and when the peel strength is equal to or less than the upper limit described above, opening is absolutely possible even for an elderly or crippled patient and for those weak in strength. On the other hand, the peel strength in the middle of opening is preferably not less than 0.003 N and not more than 30 N, and particularly preferably not less than 0.01 N and not more than 15 N. When the peel strength is within the preferred range described above, opening is absolutely possible even for an elderly or crippled patient and for those weak in strength, and it is also possible to ensure sufficient sealing properties of the tablet packaging body and to prevent the unexpected opening. The peel strength described above is a value obtained by multiplying the adhesion force per unit as determined by the 180 degree peel measurement (peel strength) by the peeling width (adhesion width in the direction perpendicular to the peeling direction).

In addition, since it is possible to suppress the complete separation of the sealing member from the recessed section as the peel strength increases in the middle of opening, it is possible to prevent the patient from accidentally swallowing the sealing member.

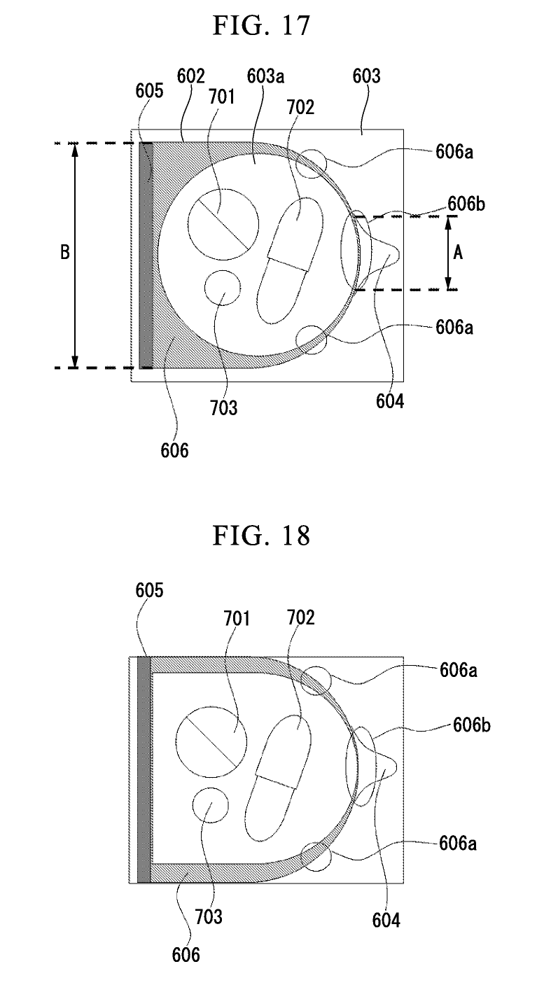

The method of designing the peel strength described above is not particularly limited, and examples thereof include a design method such as those providing a difference in the thickness of an adhesive that is used to bond the recessed section (main body sheet) and the sealing member. When a width of an adhesion area at an opening start point (area where the sealing member is adhered to the main body sheet) is defined as A and a width of an adhesion area at an opening end point (area where the sealing member is adhered to the main body sheet) is defined as B, it is preferable to design the recessed section (main body sheet) and the sealing member so that A and B satisfies a relationship of A<B. In FIG. 17, as the opening end point, a point where an adhesion portion 605 (release stopping portion) is provided is shown, although it is preferably a point for opening ¾ or more of the total surface area of the recessed section 603a in view of the handling properties including the insertion or extraction of the tablets (drugs). By designing in this manner, it is possible to make the peel strength at the start of opening lower than the peel strength in the middle of opening, without altering the composition design of the adhesive. Examples of methods for preparing such a design include a method of sealing the edge portion of the recessed section with a line seal by using a sealing member having a size capable of covering the entire recessed section; a method of sealing at the edge portion of the recessed section with a line seal by designing the sealing member in a shape slightly larger than the portion for introducing the tablets in the recessed section in advance; and a method in which the entire recessed section is sealed with a sealing member and cuts are made in the sealing member in a shape slightly larger than the portion for introducing the tablets in the recessed section.

Here, A is preferably not less than 0.1 mm and not more than 10 mm, and particularly preferably not less than 0.5 mm and not more than 5 mm. When A is equal to or more than the lower limit described above, it is possible to sufficiently seal the aforementioned tablet packaging body, and it is possible to prevent the unintended separation of the sealing member during storage of the aforementioned tablet packaging body after sealing. On the other hand, when A is equal to or less than the upper limit described above, it is possible to lower the peel strength at the start of opening, and opening is absolutely possible even for an elderly or crippled patient and for those weak in strength. Meanwhile, B is preferably not less than 20 mm and not more than 50 mm, and particularly preferably not less than 30 mm and not more than 40 mm. When A is the within the range described above, since it is possible to suppress the complete separation of the sealing member from the recessed section as the peel strength becomes sufficiently strong at the end of opening, it is possible to prevent the patient from accidentally swallowing the sealing member.

It is preferable to make the aforementioned tablet packaging body so that the aforementioned sealing member does not separate in a part of the edge of the aforementioned recessed section. Since it is possible to suppress the complete separation of the sealing member from the recessed section by adopting such a structure, it is possible to prevent the patient from accidentally swallowing the sealing member.

In the assembly of tablet packaging bodies which is formed by connecting a plurality of the aforementioned tablet packaging bodies, it is preferable that the aforementioned recessed section be provided in plurality, and that a groove or cut be provided in the main body sheet and the sealing member for each of the aforementioned recessed sections so as to surround the aforementioned recessed section, thereby forming it to be separable in each of the aforementioned recessed sections. By adopting such a structure, since a groove or cut is provided in the periphery of each recessed section among the plurality of recessed sections, it is possible to separate each recessed section. In addition, it is possible to carry around the required number of, or even any number of, tablet packaging bodies, thereby enhancing the convenience. Furthermore, the size of each recessed section is preferably a size that is difficult to pass through the throat of the human body, as in the first embodiment described above, as a result of which accidental swallowing of the tablet packaging body can be reliably prevented. As a method of designing these cuts, for example, there is a perforation process, a half cut process, or the like.

In the aforementioned tablet packaging body, it is preferable that a plurality of recessed sections and a plurality of sealing member be provided, and that the sealing member be provided for each recessed section. By adopting such a structure, it is possible to perform opening on a recessed section to recessed section basis. As a result, it is possible to prevent the peeling of the sealing member of the unintended recessed section at the time of peeling the sealing member or at the time of separating the recessed section, and the oxidation or degradation of the tablet inside the tablet packaging body can be suppressed.

In the aforementioned tablet packaging body, the height (depth) of the recessed section is more preferably equal to or more than the height of one tablet of the highest tablet and less than the height of two tablets of the lowest combination of tablets. By adopting such a structure, the tablets do not overlap in the recessed section. In other words, even in the case of image processing the inspection of the presence and absence of the tablets in the recessed section, it is possible to easily detect the number of tablets or the defects of the tablets.

In the aforementioned tablet packaging body, it is preferable that the aforementioned sealing member have a winding property, and the sealing member take a warped shape in the direction opposite to the recessed section or a wound shape when peeling the sealing member from the recessed section. By adopting such a structure, since the sealing member after opening is not located in the vicinity of the opening, it is possible to easily retrieve and take orally a plurality of tablets.

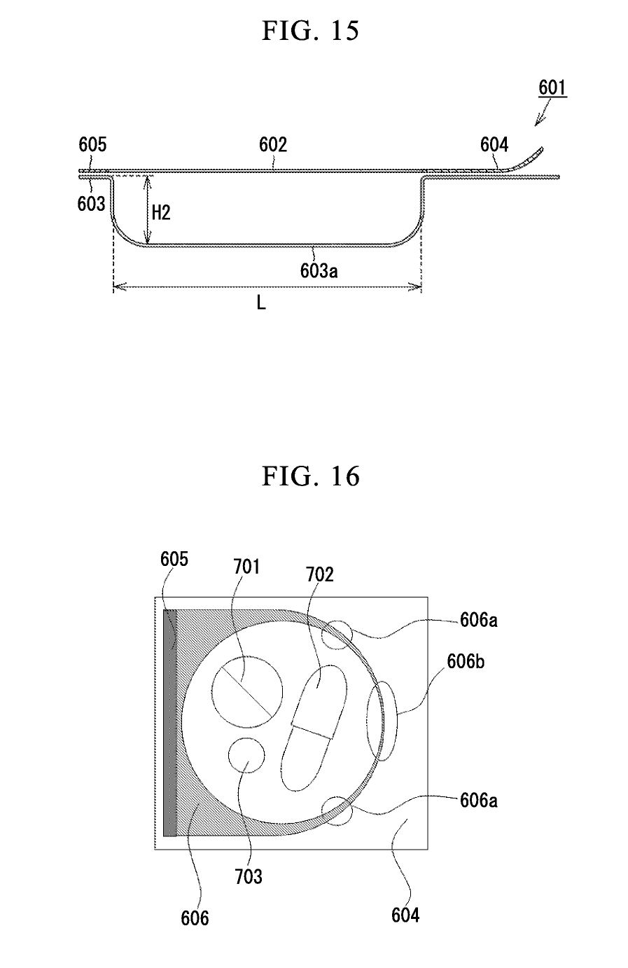

The present embodiment will be described below in more detail. The tablet packaging body according to the present embodiment is composed of an assembly of a plurality of tablet packaging bodies. FIG. 14 is a schematic perspective view showing an example of an assembly 600 of the tablet packaging body according to the present embodiment, FIG. 15 is a schematic sectional side view for explaining the structure of a tablet packaging body 601, and FIGS. 16 to 20 are schematic plan views showing an example of the tablet packaging body 601.

As shown in FIG. 14, the assembly 600 of tablet packaging bodies is formed by connecting a plurality of the tablet packaging bodies 601. One tablet packaging body 601 has a length L101 and a width D101. In addition, from the viewpoint of convenience during carrying around, it is preferable that the longitudinal direction of the assembly 600 of tablet packaging bodies be not more than 360 mm, and the transverse direction thereof be not more than 360 mm.

In addition, the length L101 is preferably greater than 10 mm and not more than about 50 mm, and the width D101 is preferably greater than 10 mm and not more than about 50 mm. That is, if the size is not 10 mm or greater, it is impossible to place two of the smallest tablets, and if the size is 50 mm or less, the size is large enough to easily house at least 10 pieces of the largest capsules and also filling can be carried out smoothly so that drugs do not overlap with each other, and thus the convenience such as portability is also excellent.

In addition, between the individual tablet packaging bodies 601, intermittent grooves (slits) 610 are provided.

As shown in FIG. 15, the tablet packaging body 601 has a bottom portion (main body sheet) 603 including a recessed section 603a mainly having transparency and a sealing member 602 for sealing the recessed section.

In addition, the recessed sections 603a are formed so that the distance between the adjacent recessed sections 603a is at least within a range of 5 mm or more and 80 mm or less. This is because it becomes difficult to open when this distance becomes 5 mm or less, and handling becomes difficult when this distance becomes 80 mm or more.

In addition, the bottom portion (main body sheet) 603 including the recessed section 603a and the sealing member 602 for sealing the recessed section are bonded, for example, by being heat sealed with a sealing machine or by an impulse system.

Next, as shown in FIGS. 15 to 20, a non-adhesion portion (turning portion) 604 and the adhesion portions 605 and 606 are provided, respectively, in a portion of the sealing member 602 of the tablet packaging body 601. Here, the adhesion portion (release stopping portion) 605 provided on the side opposite to the turning portion 604 via the recessed sections 603a is preferably one that does not peel off. By preparing the adhesion portion 605 as one that does not peel off, complete separation of the sealing member 602 can be prevented, and it is possible to prevent the patient from accidental swallowing. In addition, it is also possible to bond the recessed section 603a and the sealing member 602 with different materials from those of the adhesion portions 605 and 606, or to bond with the same materials. Even with the same adhesive material, since the width of the separated portion is different in the adhesion portions 606a and 606b upon opening, with respect to the peel strength, the peel strength of the adhesion portion 606a in which the width of the separated portion is wide becomes greater than the peel strength of the adhesion portion 606b having a narrow peeling width, thereby making it possible to prevent the sealing member from being completely peeled off. Note that a lid portion (sealing member) 602 is preferably one that has a peel strength obtained by 180 degree peel measurement of not less than 30 g/15 mm and not more than 800 g/15 mm, and more preferably not less than 50 g/15 mm and not more than 500 g/15 mm.

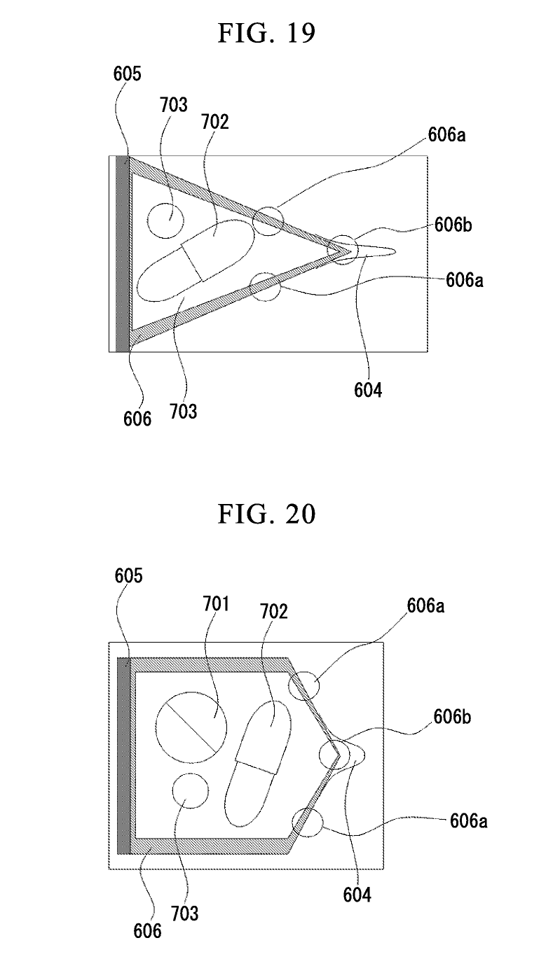

In addition, as shown in FIGS. 17 to 20, the shape of the recessed section 603a is preferably such that the width of the opening end portion is wide, as compared with the width of the opening start portion. By adopting such a structure, when the width of the adhesion region is sealed with a line seal, the width of an adhesion area at the opening start point is defined as A, and the width of an adhesion area at the opening end point is defined as B, it becomes easier to achieve a design that satisfies a relationship of A<B. In order to produce the recessed section 603a with such a structure, it is preferable that, for example, an arc shape is introduced to the turning portion 604 or the opening start portion in the recessed section 603a as shown in FIG. 17, the shape of the recessed section is made into a triangular shape as shown in FIG. 18, or the recessed section is made into a pentagonal shape as shown in FIG. 19.

The grip width of the turning portion (non-adhesion portion) 604 is preferably not less than 5 mm and not more than 50 mm, and more preferably not less than 10 mm and not more than 40 mm. It becomes difficult to grip when the grip width is less than the lower limit, and there is a tendency that the size becomes large and the handling properties become poor when the grip width exceeds the upper limit.

In addition, as shown in FIG. 15, in the bottom portion (main body sheet) 603 of the tablet packaging body 601, the recessed section 603a is formed by thermoforming. It is provided within a range such that the height (depth) H2 of the recessed section 603a is greater than the height of the highest tablet among the tablets 701, 702, and 703 to be encapsulated, and is less than the height of the two lowest tablets superposed and put together among the tablets 701, 702, and 703. In addition, as shown in FIGS. 18 to 20, the planar shape of the recessed section 603a is preferably semi-circular, triangular, pentagonal, or the like, but the cross-sectional shape thereof is not particularly limited. The recessed section 603a is preferably formed in a shape that has a slope towards the gripping portion. By adopting such a shape, since it becomes easier to retrieve the tablet in the direction of the edge of the gripping portion, the tablet can be poured directly into the mouth.

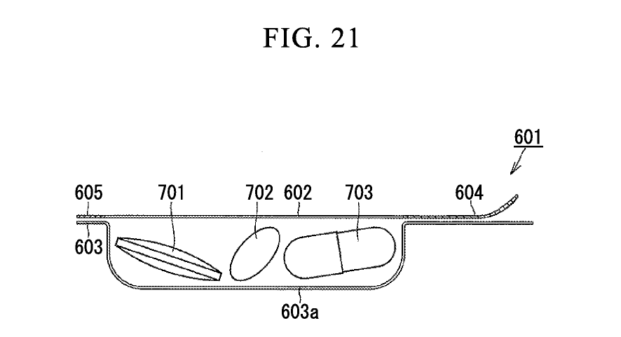

As shown in FIGS. 16 to 21, in the recessed section 603a, a plurality of tablets 701, 702, and 703 are housed. Here, the tablets 701, 702, and 703 include at least one type (preferably a plurality of types) of drug(s) to be taken at a time, supplements for health, or the like, and may be in a dosage form such as tablets, capsules, and/or pills, depending on the symptoms of the person who should take the tablets.

In addition, the sealing member 602 of the tablet packaging body 601 has a winding property. As a result, when the person who should take the tablets opens the tablet packaging body 601 while retaining the non-adhesion portion 604, because of the curl properties of the sealing member (lid portion) 602, the lid portion 602 is wound and does not shield the opening of the recessed section 603a.

It should be noted that although the main body sheet (bottom material) 603 including the recessed section 603a is to be formed of one material (base material) in the present embodiment, it is not limited thereto and may be formed by laminating a layer for imparting the necessary functions, such as a barrier layer, on the base material.

The aforementioned base material is not particularly limited, and can be formed in the same manner as that of the base layer 210 of the aforementioned first embodiment. The thickness of the base material is preferably not less than 30 μm and not more than 1,000 μm, and more preferably not less than 50 μm and not more than 800 μm.

The aforementioned barrier layer can be formed in the same manner as that of the barrier layer 220 of the aforementioned first embodiment.

In addition, similar to the main body sheet 200 of the aforementioned first embodiment, it is desirable that the main body sheet 603 including the recessed section 603a described above have transparency to an extent, so as to be able to confirm the state of the contents filled in a container, for example, whether or not the filled drug is in a prescribed manner. More specifically, it is more preferable that the total light transmittance be at least 80% and the haze be not more than 30%.

In addition, the sealing member 602 of the present embodiment is formed in the same manner as that of the sealing member 300 of the aforementioned first embodiment.

### A4

As described above, in the tablet packaging body 601 according to the present embodiment, a plurality of tablets 701, 702, and 703 can be accommodated in the recessed section 603a. Therefore, two or more types of the required tablets 701, 702, and 703 can be taken out at a time by carrying out once an operation of taking out the tablets 701, 702, and 703, so that it is possible to prevent the patient from taking the wrong type and number of tablets. In addition, since the sealing member 602 is a line seal, the volume that can contain a plurality of tablets is ensured, and a sufficient sealing property is ensured, whereas since it is made of an easy-peel type, a plurality of the tablets 701, 702, and 703 can be easily removed and taken even by an elderly or crippled patient.

### B4

In the tablet packaging body 601, with respect to the sealing member 602, in the adhesion portion 606, the peel strength at the start of opening is preferably lower than the peel strength in the middle of opening, and, for example, the peel strength at the adhesion portion (opening start portion) 606b is preferably lower than the peel strength of the adhesion portion (opening middle part) 606a. By adopting such a design, it is possible to prevent a problem such that an elderly or crippled patient cannot open due to lack of strength.

The peel strength at the opening start part 606b which is determined by the 180 degree peel measurement is preferably not less than 0.001 N and not more than 6 N, and particularly preferably not less than 0.009 N and not more than 3 N. When the peel strength is equal to or more than the lower limit described above, it is possible to sufficiently prevent the accidental opening during storage, and when the peel strength is equal to or less than the upper limit described above, opening is absolutely possible even for an elderly or crippled patient and for those weak in strength. On the other hand, the peel strength at the opening middle part 606a is preferably not less than 0.003 N and not more than 30 N, and particularly preferably not less than 0.01 N and not more than 15 N. When the peel strength is within the preferred range described above, opening is absolutely possible even for an elderly or crippled patient and for those weak in strength, and it is also possible to ensure sufficient sealing properties of the tablet packaging body and to prevent the unexpected opening.

### C4

In the tablet packaging body 601, in the adhesion portion 606 of the sealing member 602, when a width of an adhesion area at an opening start point is defined as A and a width of an adhesion area at an opening end point is defined as B, it is preferable that A and B satisfy a relationship of A<B. By adopting such a design, it is possible to prevent a problem such that an elderly or crippled patient cannot open due to lack of strength.

### D4

In the tablet packaging body 601, it is preferable that the sealing member 602 and the adhesion portion (release stopping portion) 605 as a non-peelable portion at the edge of the recessed section 603a do not separate. By such a configuration, it is possible to prevent the separation of the lid portion 602 and the recessed section 603a and to facilitate the separation of the lid portion 602 and the recessed section 603a. As a result, it is possible to prevent the accidental swallowing of the sealing member 602 when taking the tablets inside the recessed section 603a, while enhancing the opening property.

### E4

In addition, in the assembly 600 of the tablet packaging bodies 601, a plurality of the recessed sections 603a are provided, and a groove 610 is provided in the periphery of each recessed section 603a, thereby forming it to be separable in each of the recessed sections 603a. In this case, since the groove 610 is provided in the periphery of each recessed section 603a among a plurality of recessed sections 603a, it is possible to separate on a recess to recess basis. In addition, it is possible to carry around the required number of, or even any number of, tablet packaging bodies 610, thereby enhancing the convenience of the user. Furthermore, the size of each recessed section 603a is a size that is difficult to pass through the throat of the human body, as a result of which accidental swallowing can be prevented.

### F4

In addition, in the assembly 600 of the tablet packaging bodies 601, the sealing member 602 of the tablet packaging body 601 is provided for each recessed section 603a. In the assembly 600, the recessed section 603a and the sealing member 602 are each provided in plurality, and one sealing member 602 is sealed to the opening of one recessed section 603a. In this case, since the sealing member 602 as a lid portion is provided for each recessed section 603a, it is possible to carry out the opening with respect to each recessed section 603a.

### G4

In addition, in the tablet packaging body 601, it is preferable that the height (depth) H2 of the recessed section 603a be equal to or greater than the height of the highest drug among the drugs to be accommodated, and be also equal to or less than the height of the two lowest drugs put together. That is, the height of the recessed section 603a is preferably equal to or greater than the height of the tablets 701, 702, and 703, and equal to or less than the height of any two of the tablets 701, 702, and 703 put together. By designing in this manner, it is possible to prevent the tablets 701, 702 and 703 from being superposed inside the recessed section 603a. For this reason, it becomes easy to carry out the image processing of the inspection of the presence and absence of tablets inside the recessed section 603a.

In the tablet packaging body 601, the sealing member 602 preferably has the adhesion portion (release stopping portion) 605 as a non-peelable portion in a part of the periphery of the recessed section 603a. By designing in this manner, the recessed section 603a and the sealing member 602 are not separated when the sealing member 602 is opened, and it is possible to prevent accidental swallowing of the sealing member 602 when taking the tablets 701, 702 and 703 inside the recessed section 603a.

### H4

In the tablet packaging body 601, the sealing member 602 has a winding property, and the sealing member 602 becomes a warped shape when the sealing member 602 is peeled off from the recessed section 603a. Therefore, since the sealing member 602 after opening is not located in the vicinity of the opening, it is possible to easily retrieve and take orally a plurality of tablets 701, 702, and 703.

In the present embodiment, the tablets 701, 702, and 703 correspond to a plurality of drugs, the bottom portion 603 including the recessed section 603a corresponds to the main body sheet, the lid portion 602 corresponds to the sealing member, the tablet packaging body 601 and the assembly 600 of the tablet packaging bodies 601 correspond to the tablet packaging body, the adhesion portion 605 is an adhesion portion which preferably does not peel off and corresponds to a part of the edge of the recessed section, the adhesion portion 606 is an adhesion portion which is easily peelable upon opening and corresponds to a part of the edge of the recessed section, and the groove 610 corresponds to the groove or cut.

### INDUSTRIAL APPLICABILITY

The tablet packaging body according to the present invention enables even an elderly or crippled patient (the recipient of the drug) to easily take out a plurality of drugs from the tablet packaging body at a time, and makes the drug management easy.

### REFERENCE SIGNS LIST

100, 100a, 100b, 100c: Tablet packaging body;
200, 200a, 200b: Main body sheet;
230, 231, 232, 233, 234: Recessed section;
300, 300c: Sealing member;
400, 400a, 400b, 400c: Tablet packaging body;
410, 410a: Main body sheet;
413, 413a, 413b: Recessed section;
415: Slit;
420, 420c: Sealing member;
T10, T20: Drug;
600: Assembly of tablet packaging body;
601: Tablet packaging body;
602: Lid portion (sealing member);
603a: Recessed section;
603: Bottom portion (main body sheet);
604: Non-adhesion portion (turning portion);
605: Adhesion portion (release stopping portion);
606: Adhesion portion;
606a: Adhesion portion (peeling middle portion);
606b: Adhesion portion (peeling start portion);
610: Groove (slit);
701, 702, 703: Tablet (drug)

1. A tablet packaging body comprising:
at least one recessed section having a size capable of accommodating a plurality of drugs;
a main body sheet having said recessed section; and
a sealing member sealed to said main body sheet so as to cover an opening of said recessed section;
wherein said sealing member can be easily peeled from at least a part of said main body sheet such that said recessed section is opened.

2. The tablet packaging body according to claim 1,
wherein at least one of said main body sheet and said sealing member has a barrier property against at least one of specific gas and light.

3. The tablet packaging body according to claim 1,
wherein said main body sheet comprises a plurality of said recessed sections; and
at least one: of day of the week, time of day, and date, for taking said drugs accommodated in said recessed section is described on at least one of said main body sheet and said sealing member so as to each correspond to said recessed section.

4. The tablet packaging body according to claim 1, wherein said recessed section comprises a plurality of compartments.

5. The tablet packaging body according to claim 1,
wherein said main body sheet is in a strip form which can be wound into a roll, and
the said recessed section is at least provided in plurality along a longitudinal direction of said main body sheet.

6. The tablet packaging body according to claim 5, wherein a slit is formed in a width direction in said main body sheet.

7. The tablet packaging body according to claim 1, wherein said sealing member is sealed by a line seal.

8. The tablet packaging body according to claim 7, wherein a peel strength upon opening said sealing member is lower than a peel strength in the middle of opening.

9. The tablet packaging body according to claim 7, wherein when a width of an adhesion area at an opening start point is defined as A and a width of an adhesion area at an opening end point is defined as B, A and B satisfies a relationship of A<B.

10. The tablet packaging body according to claim 1, wherein said sealing member does not peel off in a part of an edge of said recessed section.

11. The tablet packaging body according to claim 7,
wherein said recessed section is provided in plurality; and
in said main body sheet and said sealing member, for each of said recessed sections, a groove or a cut is provided in a periphery of said recessed section which is formed so that said recessed sections are each separable.

12. The tablet packaging body according to claim 7, wherein said sealing member is provided for each of said recessed sections.

13. The tablet packaging body according to claim 7,
wherein a height of said recessed section is equal to or greater than a height of said drug and is equal to or lower than a height of two of said drugs put together.

14. The tablet packaging body according to claim 7,
wherein said sealing member has a winding property, and said sealing member becomes a warped shape in a direction opposite to that of the recessed section when said sealing member is peeled off from said recessed section.
